(19) United States
(12) Patent Application Publication
(10) Pub. No.: US 2019/0286567 A1
(43) Pub. Date: Sep. 19, 2019

(54) System, Apparatus And Method For Adaptively Buffering Write Data In A Cache Memory

(71) Applicant: Intel Corporation, Santa Clara, CA (US)

(72) Inventors: Mainak Chaudhuri, Kanpur (IN); Jayesh Gaur, Bangalore (IN); Sreenivas Subramoney, Bangalore (IN); Hong Wang, Santa Clara, CA (US)

(21) Appl. No.: 15/923,174

(22) Filed: Mar. 16, 2018

(51) Int. Cl. G06F 12/0895; G06F 12/0891; G06F 12/0804; G06F 12/12

(52) U.S. Cl. CPC G06F 12/0895; G06F 12/0891; G06F 12/0804; G06F 2212/604; G06F 2212/1016; G06F 2212/601; G06F 12/12

(57) ABSTRACT

In one embodiment, a processor includes: a cache memory to store a plurality of cache lines; and a cache controller to control the cache memory. The cache controller may include a control circuit to allocate a virtual write buffer within the cache memory in response to a bandwidth on an interconnect that exceeds a first bandwidth threshold. The cache controller may further include a replacement circuit to control eviction of cache lines from the cache memory. Other embodiments are described and claimed.

### TECHNICAL FIELD

Embodiments relate to control of a cache memory hierarchy of a processing device.

### BACKGROUND

In typical processor-based systems, a processor couples to one or more memory devices with which it communicates information. As processor speeds continue to increase, memory, and the processor's interaction with memory, becomes a bottleneck to performance enhancements. This is the case, as memory bandwidth and latency continues to limit the performance of both single core and multi-core workloads. A large last level cache (LLC) within the processor can help reduce the fraction of memory requests served by the memory and improve performance. Typically LLCs seek to increase hit rate within the LLC in order to reduce traffic to the memory. However such operation does not take memory efficiency into account. As an example, data evicted from the LLC (victim data) and written to the memory may consume large amounts of memory bandwidth, reducing available for incoming memory traffic, resulting in lower delivered bandwidth from the memory. This situation thus adversely affects performance.

### BRIEF DESCRIPTION OF THE DRAWINGS

FIG. 1 is a block diagram of a portion of a system in accordance with an embodiment.

FIG. 2 is a block diagram of a portion of a cache hierarchy in accordance with an embodiment of the present invention.

FIG. 3 is a flow diagram of a method in accordance with an embodiment.

FIG. 4 is a flow diagram of a method in accordance with another embodiment of the present invention.

FIG. 5 is a flow diagram of a method in accordance with yet another embodiment of the present invention.

FIG. 6 is a block diagram of a micro-architecture of a processor core in accordance with one embodiment of the present invention.

FIG. 7 is a block diagram of a micro-architecture of a processor core in accordance with another embodiment.

FIG. 8 is a block diagram of a micro-architecture of a processor core in accordance with yet another embodiment.

FIG. 9 is a block diagram of a micro-architecture of a processor core in accordance with a still further embodiment.

FIG. 10 is a block diagram of a processor in accordance with another embodiment of the present invention.

FIG. 11 is a block diagram of a representative SoC in accordance with an embodiment of the present invention.

FIG. 12 is a block diagram of another example SoC in accordance with an embodiment of the present invention.

FIG. 13 is a block diagram of an example system in accordance with an embodiment of the present invention.

FIG. 14 is a block diagram of another example system in accordance with an embodiment of the present invention.

FIG. 15 is a block diagram of a representative computer system in accordance with an embodiment of the present invention.

FIG. 16 is a block diagram of a system in accordance with an embodiment of the present invention.

FIG. 17 is a block diagram illustrating an IP core development system in accordance with an embodiment of the present invention.

FIG. 18 is a block diagram of a register architecture according to one embodiment of the invention.

FIG. 19A is a block diagram illustrating both an exemplary in-order pipeline and an exemplary register renaming, out-of-order issue/execution pipeline according to embodiments of the invention.

FIG. 19B is a block diagram illustrating both an exemplary embodiment of an in-order architecture core and an exemplary register renaming, out-of-order issue/execution architecture core to be included in a processor according to embodiments of the invention.

FIGS. 20A, 20B illustrate a block diagram of a more specific exemplary in-order core architecture, which core would be one of several logic blocks (including other cores of the same type and/or different types) in a chip.

FIG. 21 is a block diagram of a processor that may have more than one core, may have an integrated memory controller, and may have integrated graphics according to embodiments of the invention.

FIG. 22 is a block diagram contrasting the use of a software instruction converter to convert binary instructions in a source instruction set to binary instructions in a target instruction set according to embodiments of the invention.

### DETAILED DESCRIPTION

In various embodiments, techniques are provided to control at least a portion of a cache memory hierarchy of a processor to dynamically allocate, within the cache memory hierarchy, an explicit virtual write buffer. In this way, during periods of high communication bandwidths between the processor and a memory, write interference on a memory interconnect that couples the processor to the memory may be reduced. Various features of this virtual write buffer, including its creation, allocation, maintenance and so forth may be dynamically controlled based on operating conditions, including bandwidth(s) on the memory interconnect, virtual write buffer occupancy, cache hit rates and so forth. Note that in embodiments, dynamic sizing of the virtual write buffer (or its presence at all) may be based at least in part on cache hit rate, in addition to bandwidth. In this way, the cache memory may maintain a sufficient hit rate, while improving memory efficiency and thus gaining overall performance benefits.

It is noted that by converting some portion of a cache memory such as a portion of a last level cache (LLC) to be a virtual write buffer, hit rates may be compromised, potentially impacting performance. As such, embodiments provide machine learning techniques to identify and minimize this impact. To this end, a learning mechanism may be provided that periodically profiles hit rate of a workload (e.g., one or more applications, threads, processes or so forth) using cache hardware. Based at least in part on this hit rate information, a hit rate loss may be minimized, effectively trading off a small drop in LLC hit rate in order to improve memory efficiency and gain overall performance. In an example embodiment, the techniques described herein may enable a performance gain on memory-sensitive multicore workloads.

With the embodiments described herein in which a virtual write buffer is provided within an LLC, other write buffering resources may be minimized. For example, an integrated memory controller typically includes a small amount of storage for a write buffer. By providing a cache-based virtual write buffer, the size of this resource may be kept relatively small, e.g., on the order of between approximately 2-4 kilobytes per memory controller channel. By maintaining the write buffers with a small size, performance may be enhanced, as increasing this write buffer is not a scalable solution, given area, power and timing concerns.

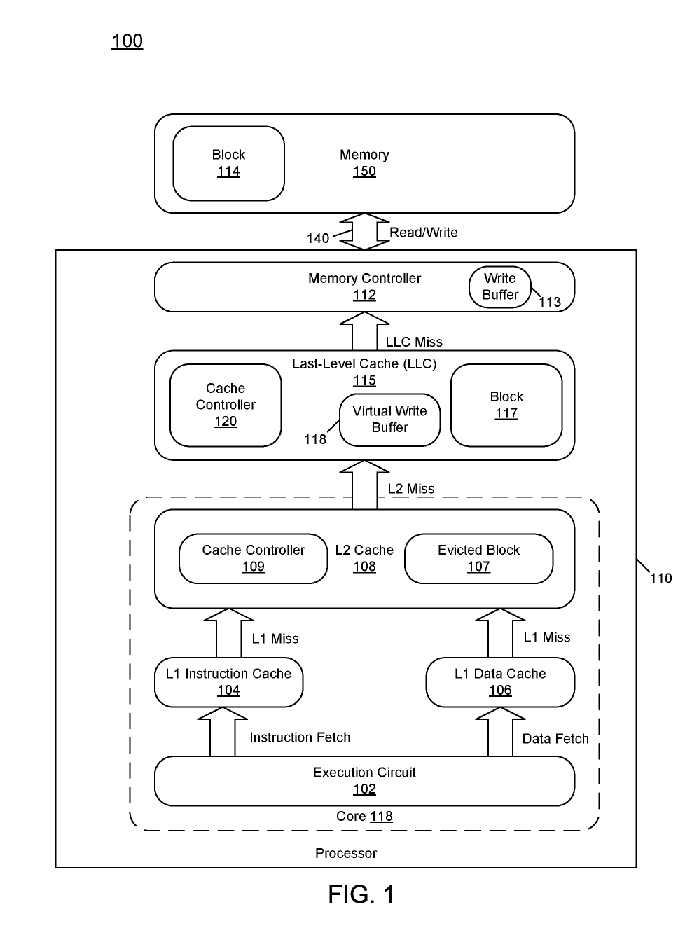

Referring now to FIG. 1, shown is a block diagram of a portion of a system in accordance with an embodiment. More specifically, FIG. 1 shows a portion of a system 100 including at least a portion of a processor 110 and a memory 150. Processor 110 may be a system on chip (SoC) or other multicore processor, and system memory 150 may be implemented as a dynamic random access memory (DRAM). Understand of course that additional components will be present in a given system, and system 100 is shown at a high level to show the general flow of data between multiple levels of a memory hierarchy of the system, including multiple cache memory levels within a processor and its system memory.

As seen, processor 100 includes an execution circuit 102, an L1 instruction cache 104, an L1 data cache 106, an L2 cache 108, a LLC 115, and a memory controller 112. Execution circuit 102 may be a portion of a processor configured to execute instructions. In some implementations, a processor may have multiple cores, with each core having a processing unit and one or more caches. FIG. 1 illustrates a three-level cache hierarchy in which L1 caches 104 and 106 are closest to execution circuit 102, L2 cache 108 is farther from execution circuit 102 compared to L1 caches 104 and 106, and LLC 115 is the farthest from execution circuit 102.

In operation, execution circuit 102 may perform an instruction fetch after executing a current instruction. The instruction fetch may request a next instruction from L1 instruction cache 104 for execution by execution circuit 102. If the instruction is present in L1 instruction cache 104, an L1 hit may occur and the next instruction may be provided to execution circuit 102 from L1 instruction cache 104. If not, an L1 miss occurs, and L1 instruction cache 104 may request the next instruction from L2 cache 108, which includes a cache controller 109.

If the next instruction is in L2 cache 108, an L2 hit occurs and the next instruction is provided to L1 cache 104. If not an L2 miss occurs, and L2 cache 108 may request the next instruction from LLC 115.

If the next instruction is in LLC 115, an LLC hit occurs and the next instruction is provided to L2 cache 108 and/or to L1 instruction cache 104. If not, an LLC miss may occur and LLC 115 may request the next instruction from memory controller 112. Memory controller 112 may read a block 114 that includes the next instruction and fill block 114 into L2 cache 108, in a non-exclusive cache hierarchy implementation. Other fill techniques of course are possible. And understand that while an instruction-based cache fill example is given, the same operations occur for a data-based fill (with the exception that the data is finally filled back to L1 data cache 106).

In some implementations, a core 118 may include execution circuit 102 and one or more of caches 104, 106, or 108. For example, in FIG. 1, core 118 includes caches 104, 106, and 108 but excludes LLC 115. In this example, LLC 115 may be shared with other cores. As another example, if core 118 includes LLC 115, LLC 115 may be private to core 118. Whether LLC 115 is private to core 118 or shared with other cores may be unrelated to whether LLC 115 is inclusive or exclusive of other caches, such as caches 104, 106, or 108.

In addition to the above discussion of fill operations, eviction operations also may be performed within the cache memory hierarchy. As shown, due to capacity issues within a lower level cache (e.g., one of L1 instruction cache 104 or L1 data cache 106) a data block 107 may be evicted and stored temporarily in storage within L2 cache 108. Still further due to capacity issues, evicted block 107 in turn may become evicted from L2 cache 108 and be provided to LLC 115 as evicted block 117.

In embodiments herein, when evicted data block 107 includes dirty data to be written back to memory 150, such dirty data may be maintained in a virtual write buffer 118 of LLC 115. As used herein, note that the term “virtual write buffer” is used to refer to a dedicated allocation of one or more cache lines (per set) within a cache memory in which dirty data are to be stored and maintained instead of cache lines storing clean data. Stated another way, a virtual write buffer is a dedicated cache memory storage for writeback data, so that such writeback data can be maintained for longer periods of time within the cache memory before an actual writeback to memory occurs, thus reducing memory traffic. At the same time, an upper bound on the size of the virtual write buffer may be maintained to ensure that hit rates within the cache memory do not impact performance to an undesired extent. As will be described in more detail herein, the presence of virtual write buffer 118 may be dynamically controlled based at least in part on a bandwidth on an interconnect 140 that couples processor 110 with memory 150.

In embodiments herein, a cache controller 120 may be configured to dynamically allocate virtual write buffer 118, dynamically control its size based at least in part on hit statistics, and adaptively drain entries from virtual write buffer 118 to memory 150 according to varying conditions, including bandwidth on interconnect 140 and/or capacity issues within virtual write buffer 118. In embodiments, virtual write buffer 118 may be implemented as an explicit write buffer. This explicit write buffer may be formed of at least a predetermined number of lines or ways within each set of LLC 115.

Note that memory controller 112 includes its own write buffer 113. However, embodiments may leverage virtual write buffer 118, implemented within already existing storage within LLC 115, such that the expense of an increased size of this additional memory structure within memory controller 112 can be mitigated. As such, virtual write buffer 118 is a separate structure from write buffer 113 of memory controller 112.

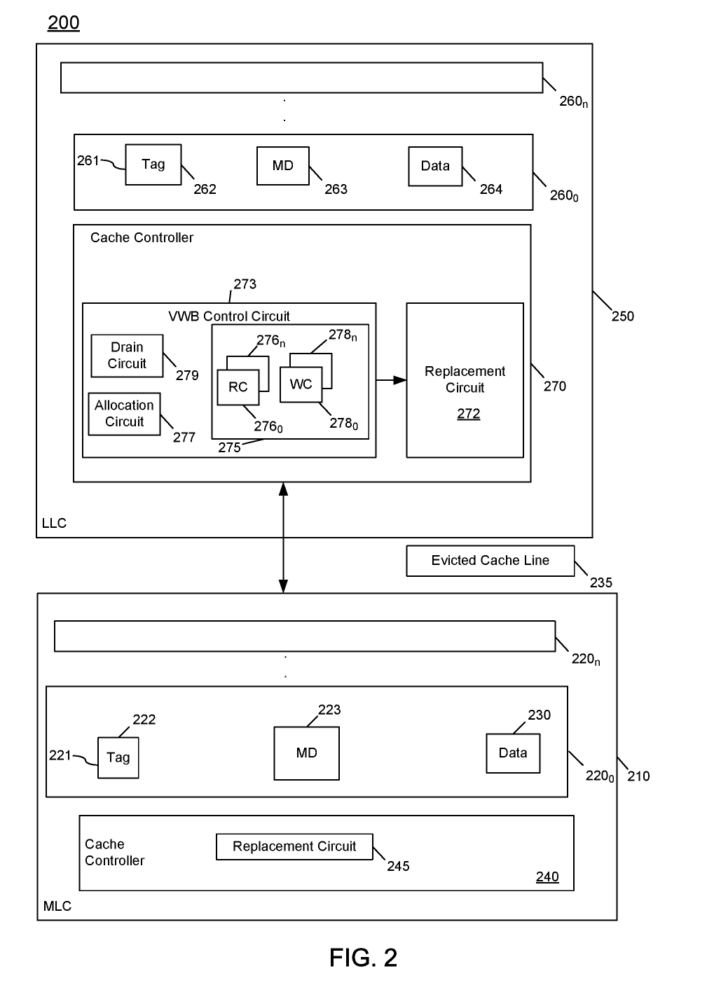

Referring now to FIG. 2, shown is a block diagram of a portion of a cache hierarchy in accordance with an embodiment of the present invention. More specifically FIG. 2 shows further details of two levels of a multi-level cache hierarchy, with included circuitry for maintaining a virtual write buffer as described herein. As seen, a cache hierarchy 200 includes two levels of cache memory, namely a mid-level cache (MLC) 210 and a LLC 250. Understand while only two levels of a hierarchy are shown, more than two levels may be present in other embodiments. As in FIG. 1 above, typically a processor may include at least three levels of cache hierarchy, including a L1 cache that is smallest and closest to a core (e.g., within the core) or other processing unit, a second level cache (such as MLC 210) and a shared or last level cache, such as LLC 250.

As illustrated in FIG. 2, MLC 210 includes a plurality of cache lines 221, a representative one of which is shown in detail in FIG. 2. In embodiments, MLC 210 may be implemented as an M-way N-set associative cache memory. Thus as illustrated, a plurality of sets 220₀-220ₙ are shown. Each such set may include a plurality of ways (e.g., M ways), each corresponding to a cache line 221. Representative details of information stored in cache line 221 are shown. Specifically, cache line 221 may include or be associated with a tag portion 222 that is used to index into the cache line. Cache line 221 further includes a metadata portion 223 including a plurality of fields to store information regarding hit information, coherency information and so forth, and a data portion 230 that stores the corresponding data of the cache line.

Still referring to FIG. 2, MLC 210 further includes a cache controller 240 that in embodiments may be a given hardware circuit, in addition to additional control logic, software and/or firmware to perform cache control operations with regard to storage of data in MLC 210. Cache controller 240 may perform various cache management operations.

For purposes of discussion herein, cache controller 240 may include a replacement circuit 245 which, when MLC 210 is at a capacity (or at least a set is at such capacity) may be used to identify an eviction candidate to be evicted from MLC 210 as an evicted cache line 235, in turn to be provided to LLC 250. In different implementations, replacement circuit 245 may perform replacement operations based on various replacement policies. For purposes of discussion herein, assume that evicted cache line 235 includes dirty data that is to be stored within LLC 250. Understand while shown with a single particular sub-circuit in the embodiment of FIG. 2, a given cache controller may include additional logic and circuitry.

As illustrated in FIG. 2, during operation MLC 210 may identify an evicted cache line, and send a communication (message 235) to LLC 250. As illustrated, LLC 250 includes a plurality of sets 260₀-260ₙ, each of which may include a plurality of ways, a representative way 261 being illustrated. LLC 250 may similarly be arranged as a set-associative cache memory. In embodiments, when allocated a virtual write buffer may be implemented using some of ways 261 of each of sets 260. As with the cache lines within MLC 210, each cache line 261 may include a tag portion 262, a metadata portion 263, and a data portion 264. In some cases, at least some of the metadata information in metadata portion 223 of MLC 210 may be included in metadata portion 263. LLC 250 further includes a cache controller 270 to perform control activities with regard to LLC 250.

Note that the virtual write buffer and its control may be implemented with very little area, as the buffer itself is formed of already existing cache lines within LLC 250. In this way, a portion of LLC 250 may be repurposed as an effective and broadly applicable virtual write buffer, controlled based at least in part on dynamic learning mechanisms.

This virtual write buffer may be configured to absorb write data. The buffered writes in turn drain out of the virtual write buffer in periods of low memory bandwidth. This virtual write buffer is dynamically adjustable and balances the conflicting goals of improving memory efficiency by absorbing writes and maintaining a good hit rate in LLC 250. The virtual write buffer dynamically grows inside LLC 250. To avoid interfering with reads when the virtual write buffer is present, an LLC fill operation seeks to find a clean victim to evict. As a result, the extent to which the virtual write buffer is allowed to grow in LLC 250 influences the availability of clean victims and the quality of victims. For example, if the virtual write buffer is allowed to grow too large, the possibility of replacing clean live blocks increases.

Of interest here, cache controller 270 includes a virtual write buffer control circuit 273. In the illustration shown, virtual write buffer control circuit 273 includes constituent sub-circuits, including an allocation circuit 277 and a drain circuit 279. Still further, control circuit 273 may maintain a set of counters 275. Of interest here, such counters may include a set of read hit counters 276₀₋ₙ and a set of write hit counters 278₀₋ₙ. In an embodiment, for a 16-way cache arrangement, there may be 16 read hit counters and 16 write hit counters, each of which may be implemented with 16 bits, in an embodiment. Such counters may count, respectively, read and write hits within particular positions of a stack, organized by recency of access.

As described herein, cache controller 270 may maintain read and write hit statistics with regard to particular LRU positions of an LRU stack using counters 276, 278. Allocation circuit 277 may trigger allocation of a virtual write buffer within LLC 250, e.g., based on bandwidth information of a memory interconnect, which may be received from a memory controller (not shown for ease of illustration in FIG. 2). Upon allocation of a virtual write buffer, allocation circuit 277 issues an allocation signal to replacement circuit 272 to cause it to update a replacement policy used in determining cache lines for eviction. In one embodiment, this update changes the replacement policy from a given LRU policy to a LRU clean policy, such that clean lines are preferentially evicted from LLC 250. This change to the replacement policy may minimize impact on memory traffic, since such clean lines are not written back to memory when they are evicted from LLC 250. Still further, allocation circuit 277 may initialize the virtual write buffer to be of a predetermined size. Then based at least in part on hit statistics maintained within counters 276, 278, control circuit 273 can dynamically update a size of the virtual write buffer. Understand while shown with this particular embodiment in FIG. 2, many variations and alternatives are possible. For example, while virtual write buffer is illustrated and discussed as being present within LLC 250, embodiments are not so limited. That is, in other embodiments the advantages of a virtual write buffer may be realized within other cache memories of a cache memory hierarchy to reduce bandwidth on other interconnects.

Hit histogram information based on the hit count information maintained by counters 276, 278 may be used to prevent hit rate loss in LLC 250. More specifically this information may be used to dynamically adjust the size of the virtual write buffer in order to limit the LLC hit rate loss. In an embodiment, the virtual write buffer is sized periodically based on two metrics. First, a bound is imposed on the percentage of sacrificed LLC hits due to implementation of the clean LRU replacement policy. Second, a bound is imposed on the probability of dirty inclusion victims.

A read hit histogram (RHH) is maintained using information from read hit counters 276. More specifically, this RHH records the number of LLC read hits in each LRU stack position. In one particular embodiment, the number of ways beginning from the tail of the LRU stack (namely the LRU position) that cover 1/16^{th} of all LLC read hits may define a maximum stretch of the virtual write buffer. Let this be called MaxReadStretch. This value guarantees that if the write buffer becomes full, a clean LRU replacement policy will not sacrifice more than 1/16^{th} of LLC hits.

A write hit histogram (WHH) is also maintained using information from write hit counters 278. More specifically, this WHH records the number of LLC write hits in each LRU stack position. In one particular embodiment, the number of ways starting from the tail of the LRU stack that cover half of all LLC write hits may define a maximum stretch of the virtual write buffer. Let this be called MaxWriteStretch. Evicting a block beyond the MaxWriteStretch has the probability of generating a dirty inclusion victim equal to (#dirty blocks/#all blocks)*inclusion victim fraction*fraction of write hits covered by MaxWriteStretch. Assuming ⅓^{rd} dirty blocks, this leads to (⅓)*(¼)*(½), or about a 4% chance of generating a dirty inclusion victim. Note that the inclusion victim fraction may be set as the ratio of MLC to LLC capacity.

In one particular embodiment, these two values may be used in determining an appropriate size of the virtual write buffer. In such embodiments, the write buffer size may be dynamically controlled to be a maximum of a predetermined (or initialization) value and these stretch values, as follows: max(3, min(MaxWriteStretch, MaxReadStretch)). In this example in other words, the minimum virtual write buffer capacity is set to 3 LLC ways. Of course, in other embodiments other values may exist, or other techniques may be used to determine the virtual write buffer size.

Different sets in the virtual write buffer fill up with dirty blocks at different rates. Some sets fill up quickly and put pressure on the clean LRU replacement policy for those sets. In embodiments there may be multiple criteria to be considered in determining when it is appropriate to drain entries from the virtual write buffer. In one embodiment, a first drain or scrub trigger may be based on the number of overflown sets in the virtual write buffer. As used herein, the term “overflown set’ means a set in which all of the number of ways that constitute the virtual write buffer include dirty data. Note that different applications can tolerate different numbers of overflown sets. For example, an application with reasonably high hit rate can sacrifice a bigger number of hits to delay a scrub operation. In one implementation, a lookup table (LUT) may be used to map hits per fill to the number of tolerable overflown sets. More specifically, the LUT may be used to identify how many overflown sets an application can tolerate. If the hits per fill is high for that application (e.g., hit rate is high), more overflown sets can be tolerated. The rationale is that since the hit rate is high, the memory bandwidth demand is lower, and hence a little decrease in hit rate will not hurt memory bandwidth demand. Note that RHH information may still cap the overall hit rate loss. In an embodiment, each set within LLC 250 may include an overflow indicator, e.g., a single bit, which when set is to indicate that the virtual write buffer for the set is full (namely each way of the virtual write buffer, to the specified depth stores dirty data). This information may be used to identify when a scrub may be triggered due to a capacity issue.

A second criterion for triggering a scrub may be based on the number of reads pending on a memory channel. In a particular system configuration, an LLC may be configured with multiple banks, where each LLC bank is associated with a specific memory channel. If the number of reads pending on that channel is higher than a threshold, scrubbing is deferred until the number of pending reads falls below the threshold. In one embodiment, this threshold may be set to: (number of miss status holding registers (MSHRs), which is a measure of pending reads in a bank))×(number of LLC banks feeding to a DRAM channel). In other words, a write scrubbing is triggered in an LLC bank only if the memory channel is not saturated with the maximum number of reads. Of course in other embodiments, a LLC-wide analysis may be performed.

In typical embodiments, each of these criteria may be considered independently, such that scrubbing is triggered when either criterion is met. In another embodiment, both the criteria may be satisfied for an LLC bank to enter the scrub mode.

In the scrub mode, cache controller 270 or other control circuit may analyze each set (e.g., one or more times or rounds). In each visit or analysis to a set, at most one dirty block closest to the LRU position may be scrubbed, in one embodiment. Note that this scrub operation may be implemented as a write of the dirty data to memory and a corresponding update to cache coherency metadata of the line to indicate that the line now stores clean data. Stated another way, this scrub of a line is a write to memory and update to the cache coherency state of the line, without victimizing the line. In one embodiment, within a set, the search for a dirty block is restricted to the lowest N LRU stack positions to minimize over scrubs. This variable N may be determined periodically by visiting the WHH and computing the number of ways, starting from the LRU tail that cover at most 1/16^{th} of all LLC write hits.

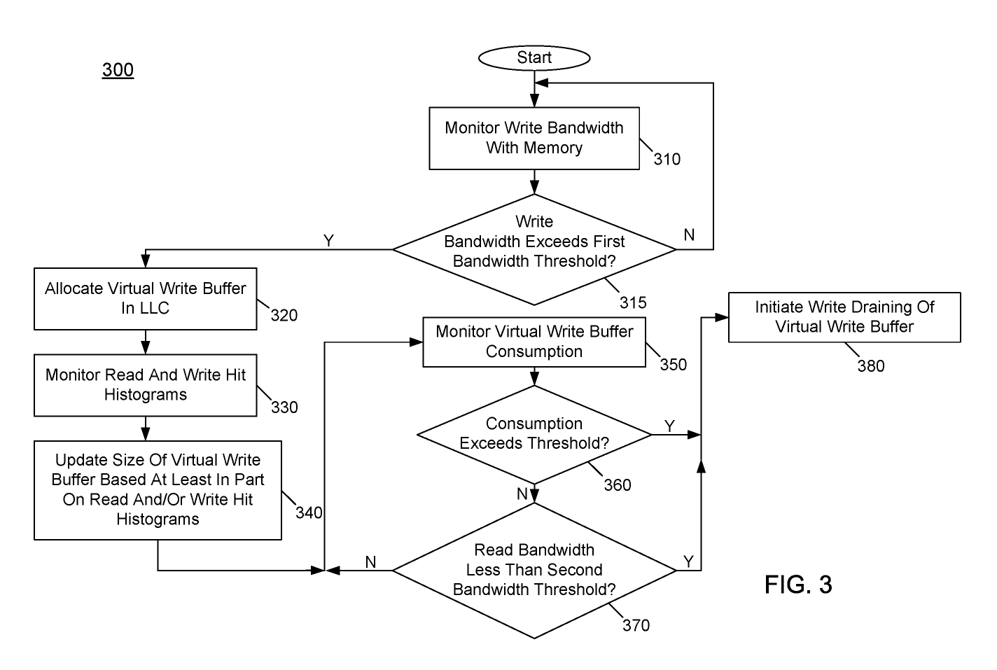

Referring now to FIG. 3, shown is a flow diagram of a method in accordance with an embodiment. More specifically, method 300 is a method for controlling a virtual write buffer as described herein. In embodiments, method 300 may be performed by a cache controller, such as an LLC cache controller, which may be implemented as one or more hardware circuits, firmware, software and/or combinations thereof.

At a high level, method 300 may be used to allocate a virtual write buffer in the LLC based on system conditions and maintain the virtual write buffer during at least portions of operation, including inserting dirty lines into entries of the virtual write buffer and adaptively draining or scrubbing these dirty lines from the virtual write buffer. Maintenance may further include dynamic control of the virtual write buffer, including dynamic sizing of the virtual write buffer, dynamic allocation/deallocation of the virtual write buffer and so forth.

As illustrated, method 300 begins by monitoring a write bandwidth with a memory (block 310). More specifically, a write bandwidth of an interconnect that couples a processor to a memory such as a DRAM can be monitored. In embodiments, an integrated memory controller of the processor may maintain such statistics regarding channel usage. As an example, statistics may be maintained as to read and write bandwidths for read and write operations on the interconnect. In different implementations, such statistics may be maintained independently for multiple channels. Furthermore, while in the embodiment of FIG. 3, the monitoring performed at block 310 is with regard to write bandwidth, understand the scope of the present invention is not limited in this regard, and in other embodiments this monitoring may be of read bandwidth or a combination of read and write bandwidths.

In any event, control next passes to diamond 315 to determine whether this monitored bandwidth exceeds a first bandwidth threshold. Although the scope of the present invention is not limited in this regard, this first bandwidth threshold may be set at a given level of bandwidth, e.g., as a percentage of maximum bandwidth. If the bandwidth is determined not to exceed this first bandwidth threshold, control passes back to block 310 for further monitoring of the bandwidth. Note that this bandwidth monitoring may occur periodically.

Still with reference to FIG. 3, if it is determined at diamond 315 that the bandwidth exceeds the first bandwidth threshold, control passes to block 320, where a virtual write buffer is allocated. More specifically, this virtual write buffer is allocated within the LLC. As generally described above, the virtual write buffer may be implemented as one or more ways within each set of the LLC. In the embodiment of FIG. 3, this allocation may be initialized at a predetermined number of ways. For example, in a cache implementation in which the LLC is arranged as an N-set 16-way associative cache memory, the predetermined number of ways may be set equal to three. Of course other examples are possible in different embodiments.

Allocation of the virtual write buffer may include additional operations, such as updating a replacement policy within the LLC. For example, the virtual write buffer allocation may be performed by updating the replacement policy to a clean LRU policy. That is, to enable a virtual write buffer as described herein, the replacement policy may be set such that clean lines are preferentially evicted from the LLC and dirty lines are not selected as victims. Note that by evicting clean lines, there is no impact on memory bandwidth, as these lines may simply be dropped, since they are clean and thus include the same data as present in the memory. Understand that in some embodiments, additional operations to allocate the virtual write buffer may occur.

At this point in operation, the virtual write buffer is allocated, such that when dirty lines are written into the LLC, they are more likely to be maintained within the LLC and be less likely to be evicted from the LLC (to the memory controller (more specifically, a write buffer within the memory controller) and in turn to the memory).

Still referring to FIG. 3, additional operations regarding dynamic maintenance and control of the virtual write buffer are further described. As illustrated, during operation, control proceeds to block 330 where read and write histograms may be monitored. More specifically as described herein, these read and write histograms provide hit statistical information regarding read and write requests that hit within the LLC at particular LRU positions within an LRU stack. That is, this statistical information is maintained by LRU position and not according to physical way information. During operation the size of the virtual write buffer can be dynamically determined based at least in part on the read and/or write hit histogram information (block 340). For example, depending upon certain so-called stretch values determined based on these histograms, the number of ways allocated for the virtual write buffer can be dynamically increased or decreased, details of which are described above.

Still further with reference to FIG. 3, during operation consumption of the virtual write buffer may be monitored (block 350). In embodiments, this consumption monitoring may be by way of identification of a number of sets within the LLC that have their virtual write buffer allocation full (e.g., by reference to an overflow indicator). For example, assume an initial configuration in which a maximum of three ways per set are allocated to the virtual write buffer. In this case, a determination of a full virtual write buffer for a set may be when these three ways (beginning with the LRU position) store dirty data. Next it may be determined based upon this monitoring whether the number of full virtual write buffer sets exceeds a threshold (diamond 360). If not, control next passes to diamond 370 where it may be determined whether a read bandwidth on the memory interconnect is less than a second bandwidth threshold. If it is not, no further operations occur, and control passes back to diamond 350.

Note with regard to FIG. 3, if it is determined at diamond 360 that the number of full virtual write buffer sets exceeds the threshold or at diamond 370 that the read bandwidth is less than the second bandwidth threshold, control passes to block 380 where a drain operation may be initiated. More specifically, this drain operation is thus an adaptive write draining of dirty lines from the virtual write buffer to memory (more specifically to the memory controller and thereafter to memory). Understand while shown at this high level in the embodiment of FIG. 3, many variations and alternatives are possible.

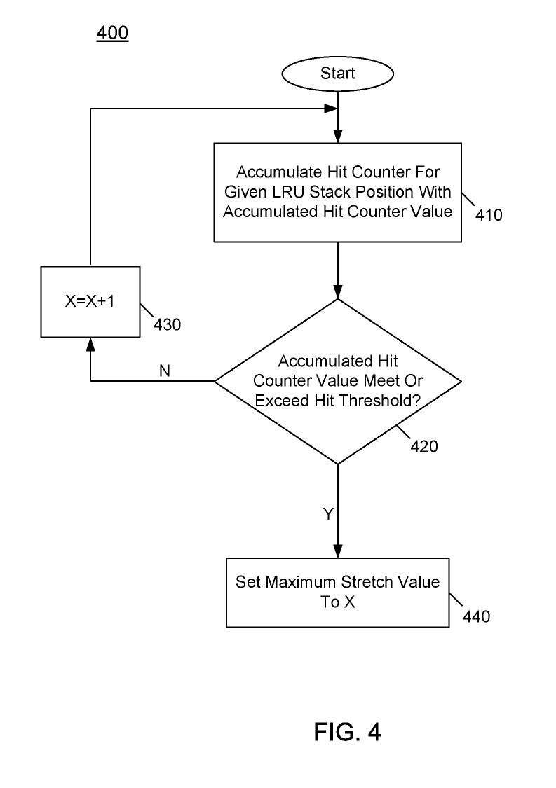

Referring now to FIG. 4, shown is a flow diagram of a method in accordance with another embodiment of the present invention. More specifically, method 400 is a method for setting values that may be used to determine a depth or size of a virtual write buffer as described herein. In embodiments, method 400 may be performed by a cache controller, such as an LLC cache controller, which may be implemented as one or more hardware circuits, firmware, software and/or combinations thereof.

As illustrated, method 400 begins by accumulating a hit counter for a given LRU stack position with an accumulated hit counter value (block 410). Note that this accumulation may begin at an LRU position by access to a hit counter associated with the LRU position (within a set of such hit counters). Thus in an initial iteration of the accumulation at block 410, this accumulated hit counter value may be set at an initialized value of zero. Understand that a cache controller may maintain independent hit counters for read and write hits. Still further, in an embodiment herein, multiple hit counters may be maintained, with a hit counter for each LRU position within an LRU stack. In an example of a cache arrangement having 16 ways, there thus may be 16 LRU positions. As such, a cache controller may maintain 16 read hit counters and 16 write hit counters. Understand that the cache controller may update the appropriate read/write hit counter on a given read or write hit to the corresponding LRU position when a request hits within that LRU position in one of the sets of the LLC.

Still with reference to FIG. 4, next it is determined at diamond 420 whether the accumulated hit count value meets or exceeds a hit threshold. Although the scope of the present invention is not limited in this regard, this hit threshold may correspond to a given percentage of hits. Note that this total number of hits can be determined by summing all of the hit counters of all LRU positions within the LRU stack. In a particular embodiment, for a read hit analysis, this hit threshold may be set to 1/16. If it is determined that the accumulated hit counter value does not meet or exceed this hit threshold, control passes to block 430 where a variable X may be incremented. Thereafter, control passes back to block 410 for accumulation of the next hit counter with the accumulated hit counter value.

Still with reference to FIG. 4, instead if it is determined at diamond 420 that the accumulated hit counter value meets or exceeds the hit threshold, control passes to block 440. At block 440 a maximum stretch value may be set equal to the value of the variable N. Assume, for purposes of example, that the accumulated hit counter value that reached the hit threshold occurred after the hit counters for four ways were accumulated. In this case, the maximum stretch value may be set to X=4.

Note that method 400 may proceed independently for read hit counters and write hit counters. As such, two different maximum stretch values may be set, one associated with read hits and the other associated with write hits. As described herein, both of these values may be used to determine a size or depth of the virtual write buffer. For example, the cache controller of the LLC may set the virtual write buffer depth to a smallest one of these two maximum stretch values, assuming that the value of whichever is the smaller maximum stretch value exceeds the baseline or predetermined virtual write buffer depth. Of course other examples are possible.

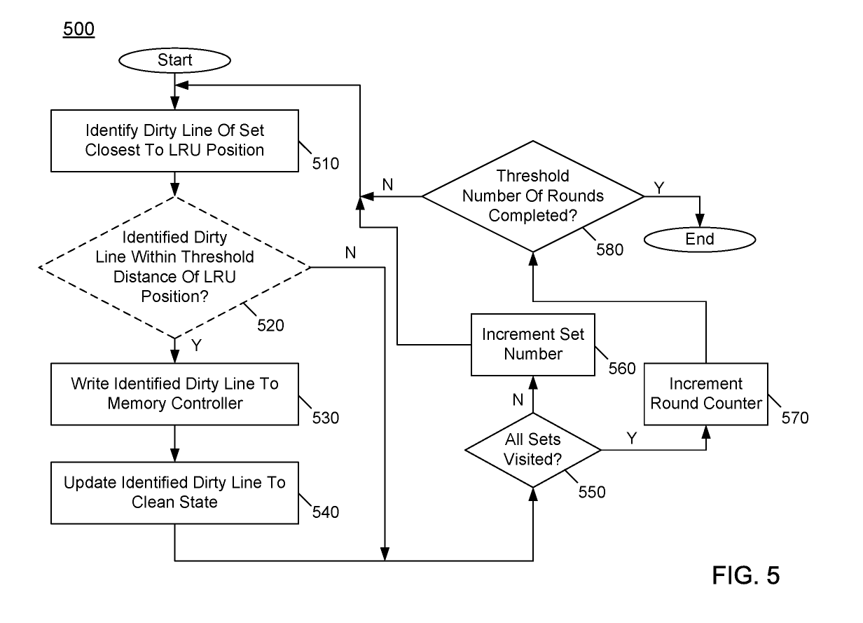

Referring now to FIG. 5, shown is a flow diagram of a method in accordance with yet another embodiment of the present invention. More specifically, method 500 may be performed by a cache controller in performing adaptive write draining or scrubbing as described herein. In embodiments, method 500 may be performed by a cache controller, such as an LLC cache controller, which may be implemented as one or more hardware circuits, firmware, software and/or combinations thereof. As illustrated, method 500 begins by identifying a dirty line of a set that is closest to the LRU position (block 510). Note that method 500 may begin in response to a trigger for draining of the virtual write buffer. This trigger may be based upon a capacity issue with regard to the virtual write buffer and/or available memory bandwidth. Of course other triggers may be possible.

As an option, it may be determined whether the identified dirty line is within a threshold distance of the LRU position itself (diamond 520). As an example, this threshold distance may restrict the search for dirty lines to the lowest N LRU stack positions, thus minimizing over scrubs. In other cases, this optional determination may not occur. In any event, control passes to block 530 where the identified dirty line may be written to the memory controller (for eventual write back to the memory). Note that this write of the identified dirty line does not cause an eviction of the dirty line. Instead as further shown in FIG. 5 at block 540 the status or metadata associated with the dirty line can be updated to a clean state, as the memory will be updated with the newly written information. By not evicting this line at this point during the scrub operation, the information remains in the LLC where it may be hit one or more times prior to eviction, improving hit rates, while at the same time providing the dirty data to memory.

Still with reference to FIG. 5, control next passes to diamond 550 where it is determined whether all sets within the LLC have been visited in a given round of this adaptive write draining. If not all sets have been visited control passes to block 560, where the set number may be incremented. After this increment to set number occurs, control passes back to block 510 where the next set may be analyzed to identify a given dirty line.

Still referring to FIG. 5, if instead it is determined that all sets have been visited (at diamond 550), control passes to block 570 where a round counter itself may be incremented, meaning that a full round of adaptive write draining of all sets of the LLC has been performed. Next it is determined whether a threshold number of rounds of the adaptive write draining have been completed (diamond 580). Although the scope of the present invention is not limited in this regard, in one embodiment this threshold may be set at two rounds, meaning that for a given iteration or triggering of adaptive write draining, each set is visited twice, potentially leading to two dirty lines being written back to memory (via the memory controller). If the threshold number of rounds has not been completed, control passes to block 510 where another round of adaptive write draining begins. Otherwise, when it is determined that the threshold number of rounds has completed, method 500 concludes for that adaptive write draining process. Note that this adaptive write draining thus occurs for all sets of the LLC, even when only some number of the sets have full virtual write buffers. Stated another way, adaptive write draining of one or more sets may occur even though such one or more sets do not have full virtual write buffers. And as seen in the illustration of FIG. 5, for any given set of the LLC, an entry may be drained only when a dirty line is within a threshold distance of the LRU position (in an embodiment incorporating the determination at optional diamond 520). For example, assume this threshold distance is four. In this case, assuming that the 4 LRU positions of a set do not have dirty data, no draining of an entry within that set occurs during a given round of the adaptive write draining. Understand while shown at this high level in the embodiment of FIG. 5, many variations and alternatives are possible.

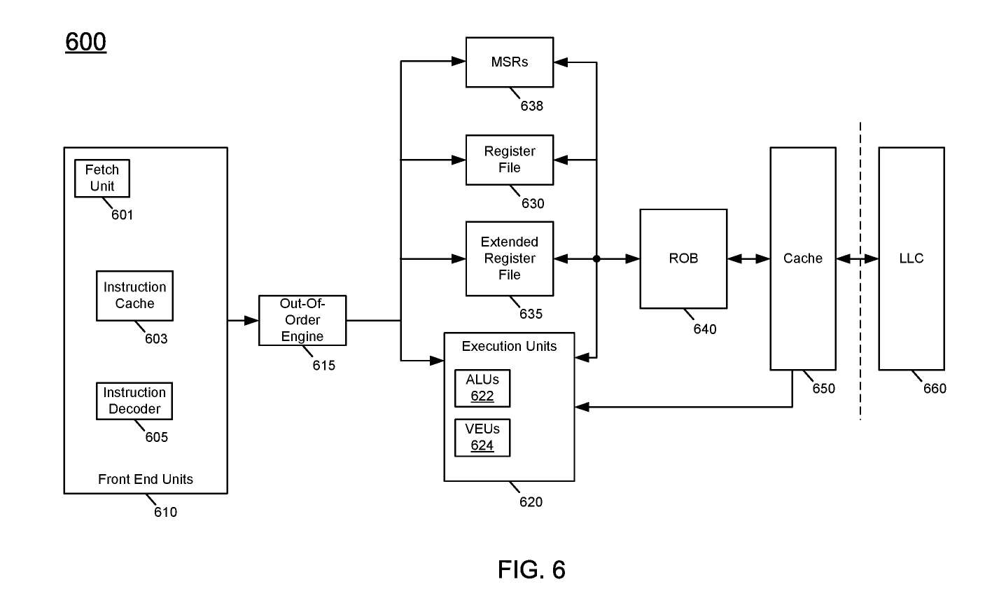

Referring now to FIG. 6, shown is a block diagram of a micro-architecture of a processor core in accordance with one embodiment of the present invention. As shown in FIG. 6, processor core 600 may be a multi-stage pipelined out-of-order processor. As seen in FIG. 6, core 600 includes front end units 610, which may be used to fetch instructions to be executed and prepare them for use later in the processor pipeline. For example, front end units 610 may include a fetch unit 601, an instruction cache 603, and an instruction decoder 605. In some implementations, front end units 610 may further include a trace cache, along with microcode storage as well as a micro-operation storage. Fetch unit 601 may fetch macro-instructions, e.g., from memory or instruction cache 603, and feed them to instruction decoder 605 to decode them into primitives, i.e., micro-operations for execution by the processor.

Coupled between front end units 610 and execution units 620 is an out-of-order (OOO) engine 615 that may be used to receive the micro-instructions and prepare them for execution. More specifically OOO engine 615 may include various buffers to re-order micro-instruction flow and allocate various resources needed for execution, as well as to provide renaming of logical registers onto storage locations within various register files such as register file 630 and extended register file 635. Register file 630 may include separate register files for integer and floating point operations. For purposes of configuration, control, and additional operations, a set of machine specific registers (MSRs) 638 may also be present and accessible to various logic within core 600 (and external to the core).

Various resources may be present in execution units 620, including, for example, various integer, floating point, and single instruction multiple data (SIMD) logic units, among other specialized hardware. For example, such execution units may include one or more arithmetic logic units (ALUs) 622 and one or more vector execution units 624, among other such execution units.

Results from the execution units may be provided to retirement logic, namely a reorder buffer (ROB) 640. More specifically, ROB 640 may include various arrays and logic to receive information associated with instructions that are executed. This information is then examined by ROB 640 to determine whether the instructions can be validly retired and result data committed to the architectural state of the processor, or whether one or more exceptions occurred that prevent a proper retirement of the instructions. Of course, ROB 640 may handle other operations associated with retirement.

As shown in FIG. 6, ROB 640 is coupled to a cache 650 which, in one embodiment may be a low level cache (e.g., an L1 cache) although the scope of the present invention is not limited in this regard. Also, execution units 620 can be directly coupled to cache 650. From cache 650, data communication may occur with higher level caches, system memory and so forth. As discussed herein, cache 650 may be in communication with higher level caches including one or more of an L2 and LLC. Thus as illustrated in FIG. 6, a higher level cache 660 (external to core 600) couples to cache 650. In embodiments herein, LLC 660 may be configured to dynamically allocate and manage an adaptive write buffer, e.g., based at least in part on memory bandwidth, to reduce memory traffic. While shown with this high level in the embodiment of FIG. 6, understand the scope of the present invention is not limited in this regard. For example, while the implementation of FIG. 6 is with regard to an out-of-order machine such as of an Intel® x86 instruction set architecture (ISA), the scope of the present invention is not limited in this regard. That is, other embodiments may be implemented in an in-order processor, a reduced instruction set computing (RISC) processor such as an ARM-based processor, or a processor of another type of ISA that can emulate instructions and operations of a different ISA via an emulation engine and associated logic circuitry.

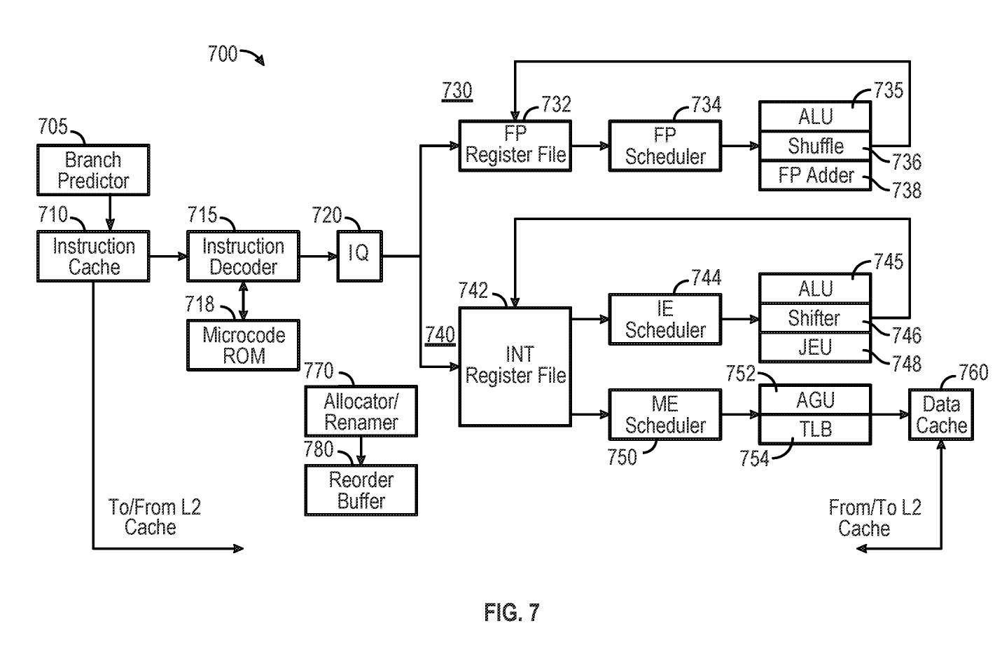

Referring now to FIG. 7, shown is a block diagram of a micro-architecture of a processor core in accordance with another embodiment. In the embodiment of FIG. 7, core 700 may be a low power core of a different micro-architecture, such as an Intel® Atom™-based processor having a relatively limited pipeline depth designed to reduce power consumption. As seen, core 700 includes an instruction cache 710 coupled to provide instructions to an instruction decoder 715. A branch predictor 705 may be coupled to instruction cache 710. Note that instruction cache 710 may further be coupled to another level of a cache memory, such as an L2 cache (not shown for ease of illustration in FIG. 7). In turn, instruction decoder 715 provides decoded instructions to an issue queue (IQ) 720 for storage and delivery to a given execution pipeline. A microcode ROM 718 is coupled to instruction decoder 715.

A floating point pipeline 730 includes a floating point (FP) register file 732 which may include a plurality of architectural registers of a given bit width such as 128, 256 or 512 bits. Pipeline 730 includes a floating point scheduler 734 to schedule instructions for execution on one of multiple execution units of the pipeline. In the embodiment shown, such execution units include an ALU 735, a shuffle unit 736, and a floating point adder 738. In turn, results generated in these execution units may be provided back to buffers and/or registers of register file 732. Of course understand while shown with these few example execution units, additional or different floating point execution units may be present in another embodiment.

An integer pipeline 740 also may be provided. In the embodiment shown, pipeline 740 includes an integer (INT) register file 742 which may include a plurality of architectural registers of a given bit width such as 128 or 256 bits. Pipeline 740 includes an integer execution (IE) scheduler 744 to schedule instructions for execution on one of multiple execution units of the pipeline. In the embodiment shown, such execution units include an ALU 745, a shifter unit 746, and a jump execution unit (JEU) 748. In turn, results generated in these execution units may be provided back to buffers and/or registers of register file 742. Of course understand while shown with these few example execution units, additional or different integer execution units may be present in another embodiment.

A memory execution (ME) scheduler 750 may schedule memory operations for execution in an address generation unit (AGU) 752, which is also coupled to a TLB 754. As seen, these structures may couple to a data cache 760, which may be a L0 and/or L1 data cache that in turn couples to additional levels of a cache memory hierarchy, including an L2 cache memory and which may be part of a cache memory hierarchy, and which may dynamically implement an adaptive write buffer as described herein.

To provide support for out-of-order execution, an allocator/renamer 770 may be provided, in addition to a reorder buffer 780, which is configured to reorder instructions executed out of order for retirement in order. Although shown with this particular pipeline architecture in the illustration of FIG. 7, understand that many variations and alternatives are possible.

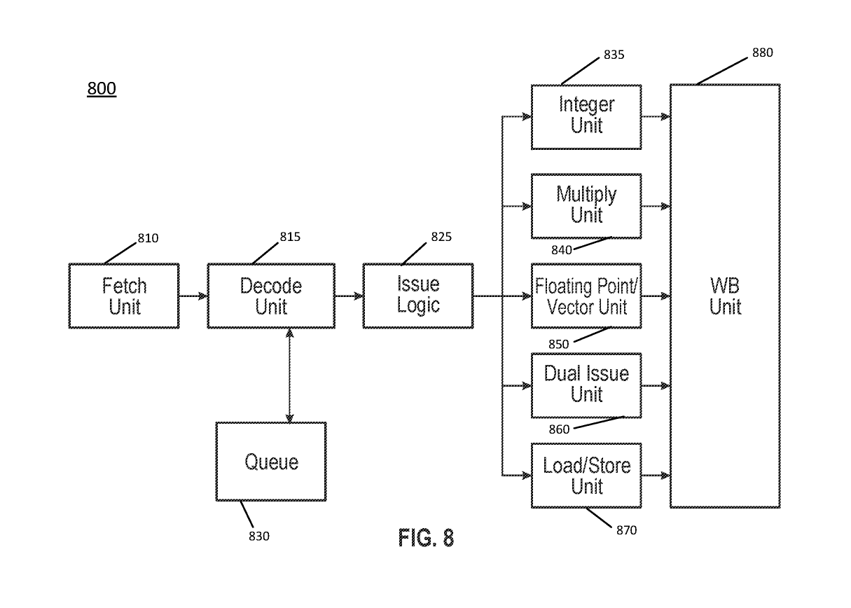

Referring to FIG. 8, shown is a block diagram of a micro-architecture of a processor core in accordance with yet another embodiment. As illustrated in FIG. 8, a core 800 may include a multi-staged in-order pipeline to execute at very low power consumption levels. As one such example, processor 800 may have a micro-architecture in accordance with an ARM Cortex A53 design available from ARM Holdings, LTD., Sunnyvale, Calif. In an implementation, an 8-stage pipeline may be provided that is configured to execute both 32-bit and 64-bit code. Core 800 includes a fetch unit 810 that is configured to fetch instructions and provide them to a decode unit 815, which may decode the instructions, e.g., macro-instructions of a given ISA such as an ARMv8 ISA. Note further that a queue 830 may couple to decode unit 815 to store decoded instructions. Decoded instructions are provided to an issue logic 825, where the decoded instructions may be issued to a given one of multiple execution units.

With further reference to FIG. 8, issue logic 825 may issue instructions to one of multiple execution units. In the embodiment shown, these execution units include an integer unit 835, a multiply unit 840, a floating point/vector unit 850, a dual issue unit 860, and a load/store unit 870. The results of these different execution units may be provided to a writeback (WB) unit 880. Understand that while a single writeback unit is shown for ease of illustration, in some implementations separate writeback units may be associated with each of the execution units. Furthermore, understand that while each of the units and logic shown in FIG. 8 is represented at a high level, a particular implementation may include more or different structures. A processor designed using one or more cores having a pipeline as in FIG. 8 may be implemented in many different end products, extending from mobile devices to server systems.

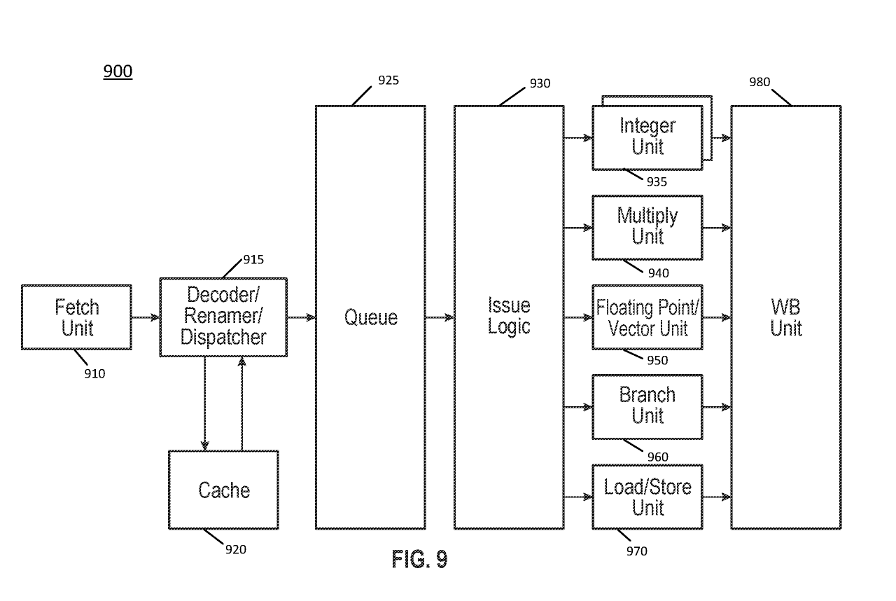

Referring to FIG. 9, shown is a block diagram of a micro-architecture of a processor core in accordance with a still further embodiment. As illustrated in FIG. 9, a core 900 may include a multi-stage multi-issue out-of-order pipeline to execute at very high performance levels (which may occur at higher power consumption levels than core 800 of FIG. 8). As one such example, processor 900 may have a microarchitecture in accordance with an ARM Cortex A57 design. In an implementation, a 15 (or greater)-stage pipeline may be provided that is configured to execute both 32-bit and 64-bit code. In addition, the pipeline may provide for 3 (or greater)-wide and 3 (or greater)-issue operation. Core 900 includes a fetch unit 910 that is configured to fetch instructions and provide them to a decoder/renamer/dispatcher unit 915 coupled to a cache 920. Unit 915 may decode the instructions, e.g., macro-instructions of an ARMv8 instruction set architecture, rename register references within the instructions, and dispatch the instructions (eventually) to a selected execution unit. Decoded instructions may be stored in a queue 925. Note that while a single queue structure is shown for ease of illustration in FIG. 9, understand that separate queues may be provided for each of the multiple different types of execution units.

Also shown in FIG. 9 is an issue logic 930 from which decoded instructions stored in queue 925 may be issued to a selected execution unit. Issue logic 930 also may be implemented in a particular embodiment with a separate issue logic for each of the multiple different types of execution units to which issue logic 830 couples.

Decoded instructions may be issued to a given one of multiple execution units. In the embodiment shown, these execution units include one or more integer units 935, a multiply unit 940, a floating point/vector unit 950, a branch unit 960, and a load/store unit 970. In an embodiment, floating point/vector unit 950 may be configured to handle SIMD or vector data of 128 or 256 bits. Still further, floating point/vector execution unit 950 may perform IEEE-754 double precision floating-point operations. The results of these different execution units may be provided to a writeback unit 980. Note that in some implementations separate writeback units may be associated with each of the execution units. Furthermore, understand that while each of the units and logic shown in FIG. 9 is represented at a high level, a particular implementation may include more or different structures.

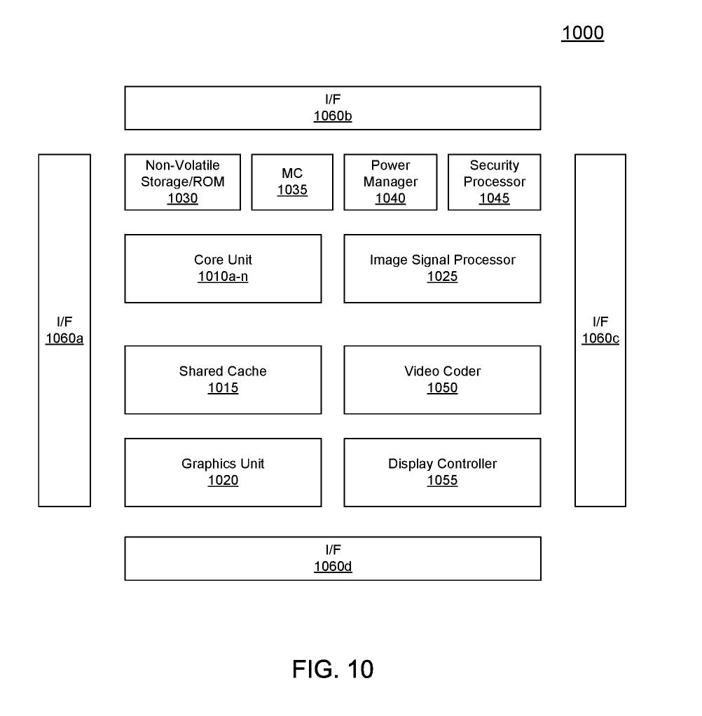

A processor designed using one or more cores having pipelines as in any one or more of FIGS. 6-9 may be implemented in many different end products, extending from mobile devices to server systems. Referring now to FIG. 10, shown is a block diagram of a processor in accordance with another embodiment of the present invention. In the embodiment of FIG. 10, processor 1000 may be a SoC including multiple domains, each of which may be controlled to operate at an independent operating voltage and operating frequency. As a specific illustrative example, processor 1000 may be an Intel® Architecture Core™-based processor such as an i3, i5, i7 or another such processor available from Intel Corporation. However, other low power processors such as available from Advanced Micro Devices, Inc. (AMD) of Sunnyvale, Calif., an ARM-based design from ARM Holdings, Ltd. or licensee thereof or a MIPS-based design from MIPS Technologies, Inc. of Sunnyvale, Calif., or their licensees or adopters may instead be present in other embodiments such as an Apple A7 processor, a Qualcomm Snapdragon processor, or Texas Instruments OMAP processor. Such SoC may be used in a low power system such as a smartphone, tablet computer, phablet computer, Ultrabook™ computer or other portable computing device, which may incorporate a heterogeneous system architecture having a heterogeneous system architecture-based processor design.

In the high level view shown in FIG. 10, processor 1000 includes a plurality of core units 1010a-1010n. Each core unit may include one or more processor cores, one or more cache memories and other circuitry. Each core unit 1010 may support one or more instruction sets (e.g., an x86 instruction set (with some extensions that have been added with newer versions); a MIPS instruction set; an ARM instruction set (with optional additional extensions such as NEON)) or other instruction set or combinations thereof. Note that some of the core units may be heterogeneous resources (e.g., of a different design). In addition, each such core may be coupled to a shared cache memory 1015 which in an embodiment may be a shared last level cache memory and which may be part of a cache memory hierarchy providing an adaptive write buffer, controllable as described herein. A non-volatile storage 1030 may be used to store various program and other data. For example, this storage may be used to store at least portions of microcode, boot information such as a BIOS, other system software or so forth.

Each core unit 1010 may also include an interface such as a bus interface unit to enable interconnection to additional circuitry of the processor. In an embodiment, each core unit 1010 couples to a coherent fabric that may act as a primary cache coherent on-die interconnect that in turn couples to a memory controller 1035. In turn, memory controller 1035 controls communications with a memory such as a DRAM (not shown for ease of illustration in FIG. 10), and may maintain bandwidth statistics used for control of an adaptive write buffer.

In addition to core units, additional processing engines are present within the processor, including at least one graphics unit 1020 which may include one or more graphics processing units (GPUs) to perform graphics processing as well as to possibly execute general purpose operations on the graphics processor (so-called GPGPU operation). In addition, at least one image signal processor 1025 may be present. Signal processor 1025 may be configured to process incoming image data received from one or more capture devices, either internal to the SoC or off-chip.

Other accelerators also may be present. In the illustration of FIG. 10, a video coder 1050 may perform coding operations including encoding and decoding for video information, e.g., providing hardware acceleration support for high definition video content. A display controller 1055 further may be provided to accelerate display operations including providing support for internal and external displays of a system. In addition, a security processor 1045 may be present to perform security operations such as secure boot operations, various cryptography operations and so forth. Each of the units may have its power consumption controlled via a power manager 1040.

In some embodiments, SoC 1000 may further include a non-coherent fabric coupled to the coherent fabric to which various peripheral devices may couple. One or more interfaces 1060a-1060d enable communication with one or more off-chip devices. Such communications may be via a variety of communication protocols such as PCIe™, GPIO, USB, I²C, UART, MIPI, SDIO, DDR, SPI, HDMI, among other types of communication protocols. Although shown at this high level in the embodiment of FIG. 10, understand the scope of the present invention is not limited in this regard.

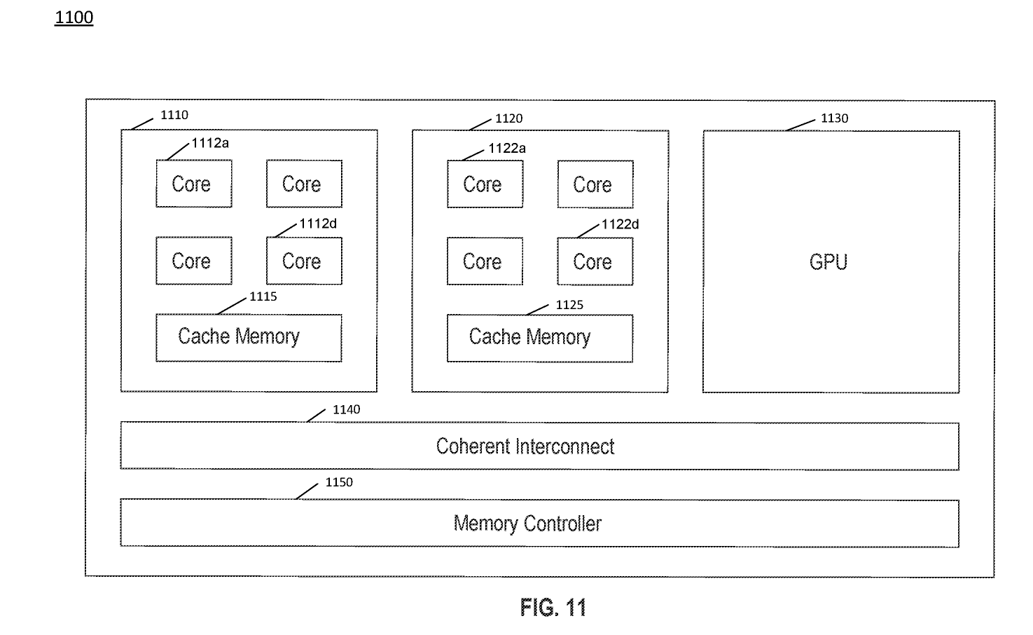

Referring now to FIG. 11, shown is a block diagram of a representative SoC. In the embodiment shown, SoC 1100 may be a multi-core SoC configured for low power operation to be optimized for incorporation into a smartphone or other low power device such as a tablet computer or other portable computing device. As an example, SoC 1100 may be implemented using asymmetric or different types of cores, such as combinations of higher power and/or low power cores, e.g., out-of-order cores and in-order cores. In different embodiments, these cores may be based on an Intel® Architecture™ core design or an ARM architecture design. In yet other embodiments, a mix of Intel and ARM cores may be implemented in a given SoC.

As seen in FIG. 11, SoC 1100 includes a first core domain 1110 having a plurality of first cores 1112a-1112d. In an example, these cores may be low power cores such as in-order cores. In one embodiment these first cores may be implemented as ARM Cortex A53 cores. In turn, these cores couple to a cache memory 1115 of core domain 1110. In addition, SoC 1100 includes a second core domain 1120. In the illustration of FIG. 11, second core domain 1120 has a plurality of second cores 1122a-1122d. In an example, these cores may be higher power-consuming cores than first cores 1112. In an embodiment, the second cores may be out-of-order cores, which may be implemented as ARM Cortex A57 cores. In turn, these cores couple to a cache memory 1125 of core domain 1120. Note that while the example shown in FIG. 11 includes 4 cores in each domain, understand that more or fewer cores may be present in a given domain in other examples. Cache memories 1115, 1125 may provide a cache memory hierarchy that has one or more adaptive write buffers, as described herein.

With further reference to FIG. 11, a graphics domain 1130 also is provided, which may include one or more graphics processing units (GPUs) configured to independently execute graphics workloads, e.g., provided by one or more cores of core domains 1110 and 1120. As an example, GPU domain 1130 may be used to provide display support for a variety of screen sizes, in addition to providing graphics and display rendering operations.

As seen, the various domains couple to a coherent interconnect 1140, which in an embodiment may be a cache coherent interconnect fabric that in turn couples to an integrated memory controller 1150. Coherent interconnect 1140 may include a shared cache memory, such as an L3 cache, in some examples. In an embodiment, memory controller 1150 may be a direct memory controller to provide for multiple channels of communication with an off-chip memory, such as multiple channels of a DRAM (not shown for ease of illustration in FIG. 11).

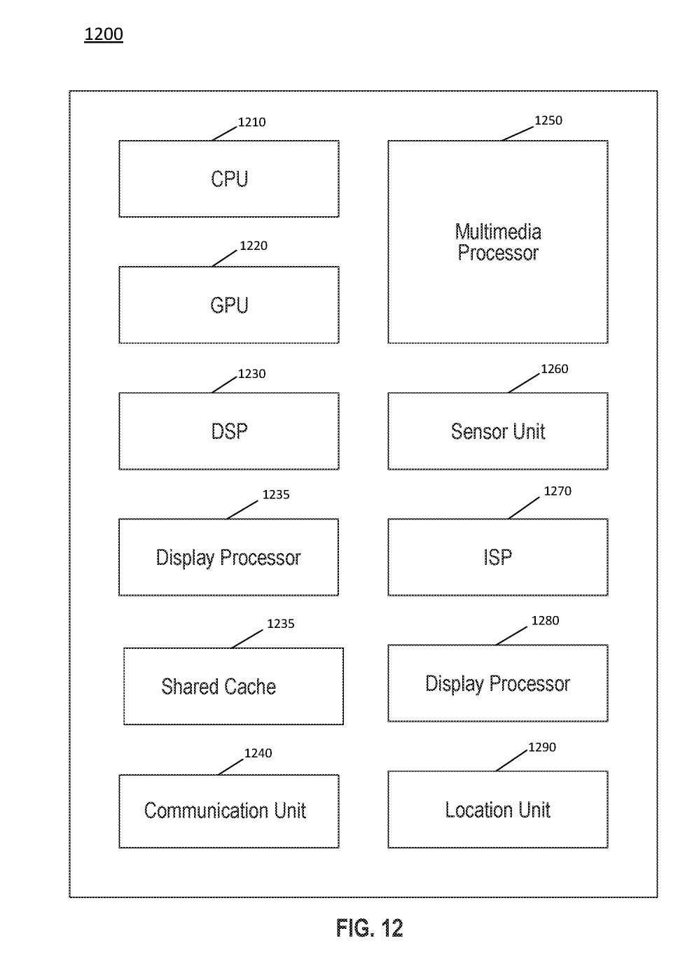

Referring now to FIG. 12, shown is a block diagram of another example SoC. In the embodiment of FIG. 12, SoC 1200 may include various circuitry to enable high performance for multimedia applications, communications and other functions. As such, SoC 1200 is suitable for incorporation into a wide variety of portable and other devices, such as smartphones, tablet computers, smart TVs and so forth. In the example shown, SoC 1200 includes a central processor unit (CPU) domain 1210. In an embodiment, a plurality of individual processor cores may be present in CPU domain 1210. As one example, CPU domain 1210 may be a quad core processor having 4 multithreaded cores. Such processors may be homogeneous or heterogeneous processors, e.g., a mix of low power and high power processor cores.

In turn, a GPU domain 1220 is provided to perform advanced graphics processing in one or more GPUs to handle graphics and compute APIs. A DSP unit 1230 may provide one or more low power DSPs for handling low-power multimedia applications such as music playback, audio/video and so forth, in addition to advanced calculations that may occur during execution of multimedia instructions.

As further illustrated, a shared cache 1235 may couple to various domains and may act as an LLC that has an adaptive write buffer as described herein. In turn, a communication unit 1240 may include various components to provide connectivity via various wireless protocols, such as cellular communications (including 3G/4G LTE), wireless local area protocols such as Bluetooth™, IEEE 802.11, and so forth.

Still further, a multimedia processor 1250 may be used to perform capture and playback of high definition video and audio content, including processing of user gestures. A sensor unit 1260 may include a plurality of sensors and/or a sensor controller to interface to various off-chip sensors present in a given platform. An image signal processor 1270 may be provided with one or more separate ISPs to perform image processing with regard to captured content from one or more cameras of a platform, including still and video cameras.

A display processor 1280 may provide support for connection to a high definition display of a given pixel density, including the ability to wirelessly communicate content for playback on such display. Still further, a location unit 1290 may include a GPS receiver with support for multiple GPS constellations to provide applications highly accurate positioning information obtained using as such GPS receiver. Understand that while shown with this particular set of components in the example of FIG. 12, many variations and alternatives are possible.

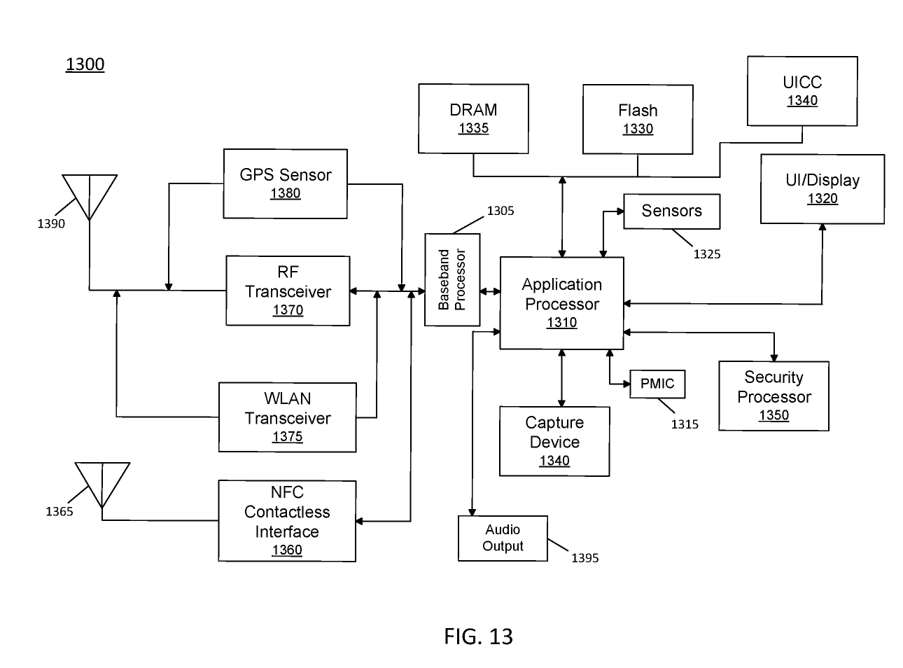

Referring now to FIG. 13, shown is a block diagram of an example system with which embodiments can be used. As seen, system 1300 may be a smartphone or other wireless communicator. A baseband processor 1305 is configured to perform various signal processing with regard to communication signals to be transmitted from or received by the system. In turn, baseband processor 1305 is coupled to an application processor 1310, which may be a main CPU of the system to execute an OS and other system software, in addition to user applications such as many well-known social media and multimedia apps. Application processor 1310 may further be configured to perform a variety of other computing operations for the device, and may include a cache memory hierarchy with adaptive write buffer as described herein.

In turn, application processor 1310 can couple to a user interface/display 1320, e.g., a touch screen display. In addition, application processor 1310 may couple to a memory system including a non-volatile memory, namely a flash memory 1330 and a system memory, namely a dynamic random access memory (DRAM) 1335. As further seen, application processor 1310 further couples to a capture device 1340 such as one or more image capture devices that can record video and/or still images.

Still referring to FIG. 13, a universal integrated circuit card (UICC) 1340 comprising a subscriber identity module and possibly a secure storage and cryptoprocessor is also coupled to application processor 1310. System 1300 may further include a security processor 1350 that may couple to application processor 1310. A plurality of sensors 1325 may couple to application processor 1310 to enable input of a variety of sensed information such as accelerometer and other environmental information. An audio output device 1395 may provide an interface to output sound, e.g., in the form of voice communications, played or streaming audio data and so forth.

As further illustrated, a near field communication (NFC) contactless interface 1360 is provided that communicates in a NFC near field via an NFC antenna 1365. While separate antennae are shown in FIG. 13, understand that in some implementations one antenna or a different set of antennae may be provided to enable various wireless functionality.

A power management integrated circuit (PMIC) 1315 couples to application processor 1310 to perform platform level power management. To this end, PMIC 1315 may issue power management requests to application processor 1310 to enter certain low power states as desired. Furthermore, based on platform constraints, PMIC 1315 may also control the power level of other components of system 1300.

To enable communications to be transmitted and received, various circuitry may be coupled between baseband processor 1305 and an antenna 1390. Specifically, a radio frequency (RF) transceiver 1370 and a wireless local area network (WLAN) transceiver 1375 may be present. In general, RF transceiver 1370 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 1380 may be present. Other wireless communications such as receipt or transmission of radio signals, e.g., AM/FM and other signals may also be provided. In addition, via WLAN transceiver 1375, local wireless communications can also be realized.

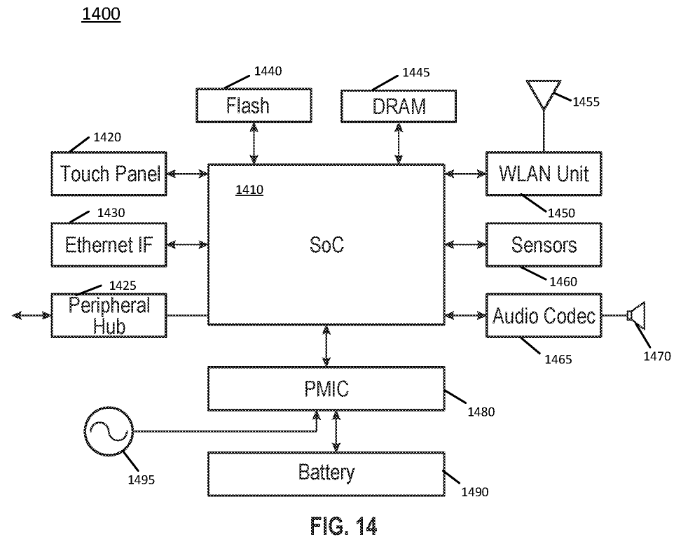

Referring now to FIG. 14, shown is a block diagram of another example system with which embodiments may be used. In the illustration of FIG. 14, system 1400 may be mobile low-power system such as a tablet computer, 2:1 tablet, phablet or other convertible or standalone tablet system. As illustrated, a SoC 1410 is present and may be configured to operate as an application processor for the device, and may include a cache memory hierarchy having an adaptive write buffer as described herein.

A variety of devices may couple to SoC 1410. In the illustration shown, a memory subsystem includes a flash memory 1440 and a DRAM 1445 coupled to SoC 1410. In addition, a touch panel 1420 is coupled to the SoC 1410 to provide display capability and user input via touch, including provision of a virtual keyboard on a display of touch panel 1420. To provide wired network connectivity, SoC 1410 couples to an Ethernet interface 1430. A peripheral hub 1425 is coupled to SoC 1410 to enable interfacing with various peripheral devices, such as may be coupled to system 1400 by any of various ports or other connectors.

In addition to internal power management circuitry and functionality within SoC 1410, a PMIC 1480 is coupled to SoC 1410 to provide platform-based power management, e.g., based on whether the system is powered by a battery 1490 or AC power via an AC adapter 1495. In addition to this power source-based power management, PMIC 1480 may further perform platform power management activities based on environmental and usage conditions. Still further, PMIC 1480 may communicate control and status information to SoC 1410 to cause various power management actions within SoC 1410.

Still referring to FIG. 14, to provide for wireless capabilities, a WLAN unit 1450 is coupled to SoC 1410 and in turn to an antenna 1455. In various implementations, WLAN unit 1450 may provide for communication according to one or more wireless protocols.

As further illustrated, a plurality of sensors 1460 may couple to SoC 1410. These sensors may include various accelerometer, environmental and other sensors, including user gesture sensors. Finally, an audio codec 1465 is coupled to SoC 1410 to provide an interface to an audio output device 1470. Of course understand that while shown with this particular implementation in FIG. 14, many variations and alternatives are possible.

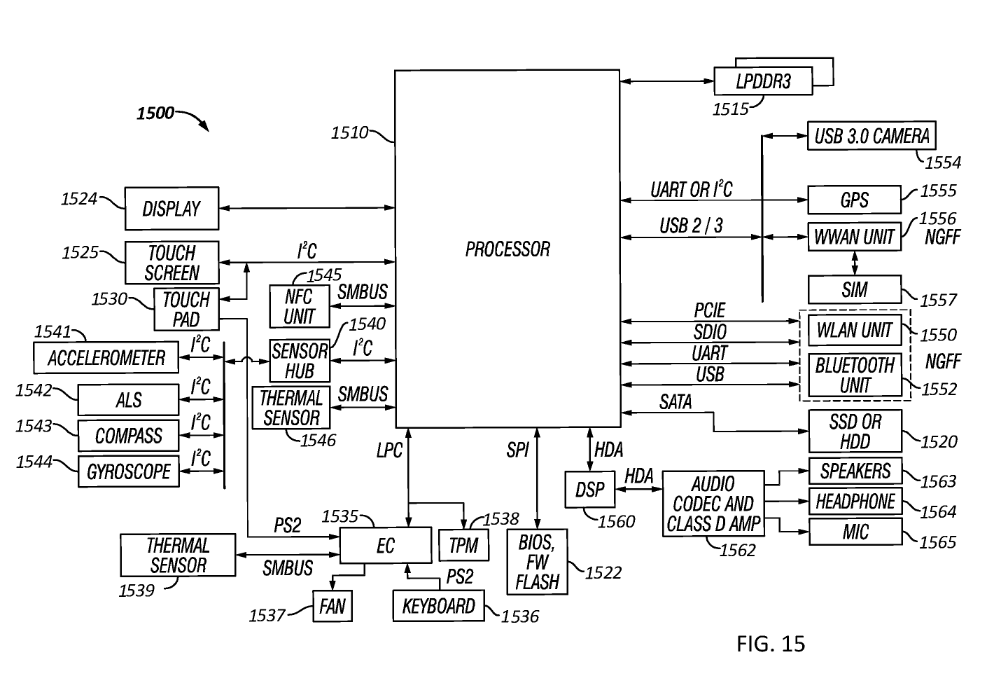

Referring now to FIG. 15, shown is a block diagram of a representative computer system such as notebook, Ultrabook™ or other small form factor system. A processor 1510, in one embodiment, includes a microprocessor, multi-core processor, multithreaded processor, an ultra low voltage processor, an embedded processor, or other known processing element. In the illustrated implementation, processor 1510 acts as a main processing unit and central hub for communication with many of the various components of the system 1500, and may include a cache memory hierarchy with one or more adaptive write buffers as described herein. As one example, processor 1510 is implemented as a SoC.

Processor 1510, in one embodiment, communicates with a system memory 1515. As an illustrative example, the system memory 1515 is implemented via multiple memory devices or modules to provide for a given amount of system memory.

To provide for persistent storage of information such as data, applications, one or more operating systems and so forth, a mass storage 1520 may also couple to processor 1510. In various embodiments, to enable a thinner and lighter system design as well as to improve system responsiveness, this mass storage may be implemented via a SSD or the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 15, a flash device 1522 may be coupled to processor 1510, e.g., via a serial peripheral interface (SPI). This flash device may provide for non-volatile storage of system software, including a basic input/output software (BIOS) as well as other firmware of the system.

Various input/output (I/O) devices may be present within system 1500. Specifically shown in the embodiment of FIG. 15 is a display 1524 which may be a high definition LCD or LED panel that further provides for a touch screen 1525. In one embodiment, display 1524 may be coupled to processor 1510 via a display interconnect that can be implemented as a high performance graphics interconnect. Touch screen 1525 may be coupled to processor 1510 via another interconnect, which in an embodiment can be an I²C interconnect. As further shown in FIG. 15, in addition to touch screen 1525, user input by way of touch can also occur via a touch pad 1530 which may be configured within the chassis and may also be coupled to the same I²C interconnect as touch screen 1525.

For perceptual computing and other purposes, various sensors may be present within the system and may be coupled to processor 1510 in different manners. Certain inertial and environmental sensors may couple to processor 1510 through a sensor hub 1540, e.g., via an I²C interconnect. In the embodiment shown in FIG. 15, these sensors may include an accelerometer 1541, an ambient light sensor (ALS) 1542, a compass 1543 and a gyroscope 1544. Other environmental sensors may include one or more thermal sensors 1546 which in some embodiments couple to processor 1510 via a system management bus (SMBus) bus.

Also seen in FIG. 15, various peripheral devices may couple to processor 1510 via a low pin count (LPC) interconnect. In the embodiment shown, various components can be coupled through an embedded controller 1535. Such components can include a keyboard 1536 (e.g., coupled via a PS2 interface), a fan 1537, and a thermal sensor 1539. In some embodiments, touch pad 1530 may also couple to EC 1535 via a PS2 interface. In addition, a security processor such as a trusted platform module (TPM) 1538 may also couple to processor 1510 via this LPC interconnect.

System 1500 can communicate with external devices in a variety of manners, including wirelessly. In the embodiment shown in FIG. 15, various wireless modules, each of which can correspond to a radio configured for a particular wireless communication protocol, are present. One manner for wireless communication in a short range such as a near field may be via a NFC unit 1545 which may communicate, in one embodiment with processor 1510 via an SMBus. Note that via this NFC unit 1545, devices in close proximity to each other can communicate.

As further seen in FIG. 15, additional wireless units can include other short range wireless engines including a WLAN unit 1550 and a Bluetooth™ unit 1552. Using WLAN unit 1550, Wi-Fi™ communications can be realized, while via Bluetooth™ unit 1552, short range Bluetooth™ communications can occur. These units may communicate with processor 1510 via a given link.

In addition, wireless wide area communications, e.g., according to a cellular or other wireless wide area protocol, can occur via a WWAN unit 1556 which in turn may couple to a subscriber identity module (SIM) 1557. In addition, to enable receipt and use of location information, a GPS module 1555 may also be present. Note that in the embodiment shown in FIG. 15, WWAN unit 1556 and an integrated capture device such as a camera module 1554 may communicate via a given link.

To provide for audio inputs and outputs, an audio processor can be implemented via a digital signal processor (DSP) 1560, which may couple to processor 1510 via a high definition audio (HDA) link. Similarly, DSP 1560 may communicate with an integrated coder/decoder (CODEC) and amplifier 1562 that in turn may couple to output speakers 1563 which may be implemented within the chassis. Similarly, amplifier and CODEC 1562 can be coupled to receive audio inputs from a microphone 1565 which in an embodiment can be implemented via dual array microphones (such as a digital microphone array) to provide for high quality audio inputs to enable voice-activated control of various operations within the system. Note also that audio outputs can be provided from amplifier/CODEC 1562 to a headphone jack 1564. Although shown with these particular components in the embodiment of FIG. 15, understand the scope of the present invention is not limited in this regard.

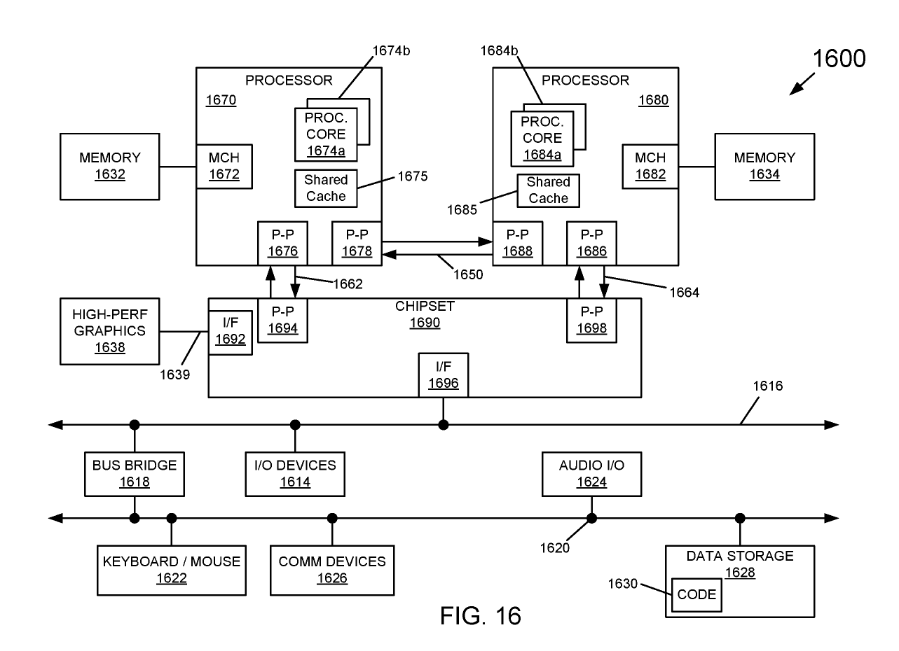

Embodiments may be implemented in many different system types. Referring now to FIG. 16, shown is a block diagram of a system in accordance with an embodiment of the present invention. As shown in FIG. 16, multiprocessor system 1600 is a point-to-point interconnect system, and includes a first processor 1670 and a second processor 1680 coupled via a point-to-point interconnect 1650. As shown in FIG. 16, each of processors 1670 and 1680 may be multicore processors, including first and second processor cores (i.e., processor cores 1674a and 1674b and processor cores 1684a and 1684b), although potentially many more cores may be present in the processors. Each of the processors includes a shared cache memory 1675, 1685 to implement adaptive write buffers, as described herein.

Still referring to FIG. 16, first processor 1670 further includes a memory controller hub (MCH) 1672 and point-to-point (P-P) interfaces 1676 and 1678. Similarly, second processor 1680 includes a MCH 1682 and P-P interfaces 1686 and 1688. As shown in FIG. 16, MCH's 1672 and 1682 couple the processors to respective memories, namely a memory 1632 and a memory 1634, which may be portions of system memory (e.g., DRAM) locally attached to the respective processors. First processor 1670 and second processor 1680 may be coupled to a chipset 1690 via P-P interconnects 1662 and 1664, respectively. As shown in FIG. 16, chipset 1690 includes P-P interfaces 1694 and 1698.

Furthermore, chipset 1690 includes an interface 1692 to couple chipset 1690 with a high performance graphics engine 1638, by a P-P interconnect 1639. In turn, chipset 1690 may be coupled to a first bus 1616 via an interface 1696. As shown in FIG. 16, various input/output (I/O) devices 1614 may be coupled to first bus 1616, along with a bus bridge 1618 which couples first bus 1616 to a second bus 1620. Various devices may be coupled to second bus 1620 including, for example, a keyboard/mouse 1622, communication devices 1626 and a data storage unit 1628 such as a disk drive or other mass storage device which may include code 1630, in one embodiment. Further, an audio I/O 1624 may be coupled to second bus 1620. Embodiments can be incorporated into other types of systems including mobile devices such as a smart cellular telephone, tablet computer, netbook, Ultrabook™, or so forth.

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

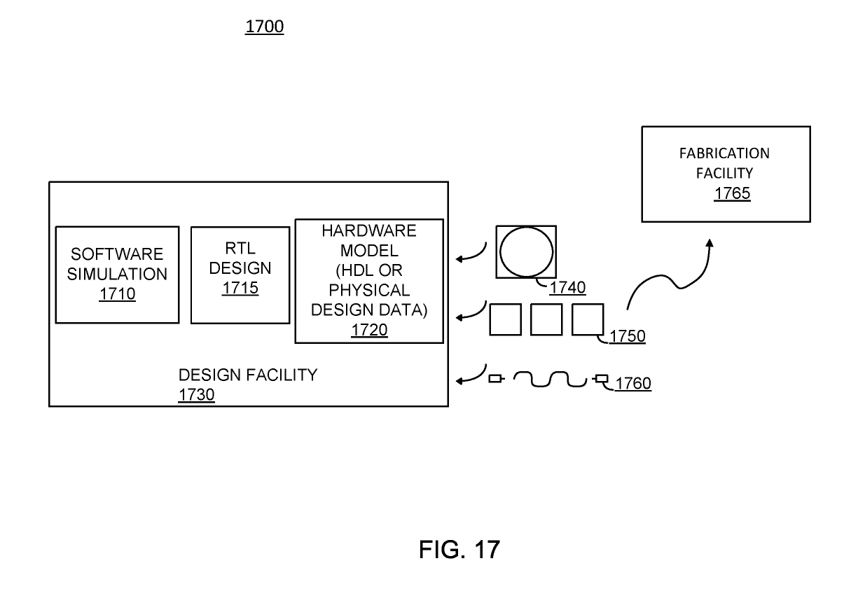

FIG. 17 is a block diagram illustrating an IP core development system 1700 that may be used to manufacture an integrated circuit to perform operations according to an embodiment. The IP core development system 1700 may be used to generate modular, re-usable designs that can be incorporated into a larger design or used to construct an entire integrated circuit (e.g., an SoC integrated circuit). A design facility 1730 can generate a software simulation 1710 of an IP core design in a high level programming language (e.g., C/C++). The software simulation 1710 can be used to design, test, and verify the behavior of the IP core. A register transfer level (RTL) design can then be created or synthesized from the simulation model. The RTL design 1715 is an abstraction of the behavior of the integrated circuit that models the flow of digital signals between hardware registers, including the associated logic performed using the modeled digital signals. In addition to an RTL design 1615, lower-level designs at the logic level or transistor level may also be created, designed, or synthesized. Thus, the particular details of the initial design and simulation may vary.

The RTL design 1715 or equivalent may be further synthesized by the design facility into a hardware model 1720, which may be in a hardware description language (HDL), or some other representation of physical design data. The HDL may be further simulated or tested to verify the IP core design. The IP core design can be stored for delivery to a third party fabrication facility 1765 using non-volatile memory 1740 (e.g., hard disk, flash memory, or any non-volatile storage medium). Alternately, the IP core design may be transmitted (e.g., via the Internet) over a wired connection 1750 or wireless connection 1760. The fabrication facility 1765 may then fabricate an integrated circuit that is based at least in part on the IP core design. The fabricated integrated circuit can be configured to perform operations in accordance with at least one embodiment described herein.

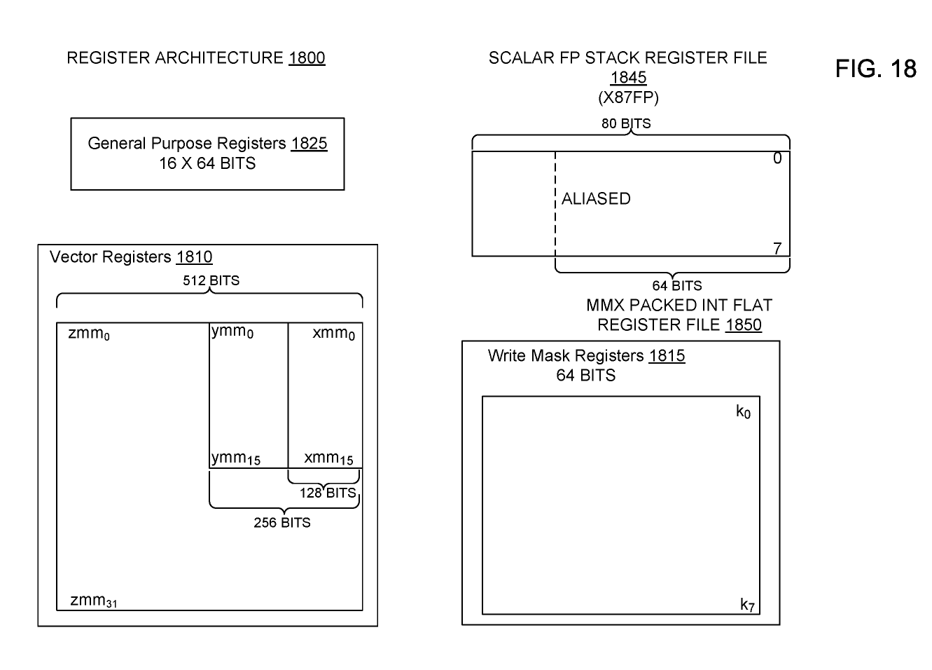

FIG. 18 is a block diagram of a register architecture 1800 according to one embodiment of the invention. In the embodiment illustrated, there are 32 vector registers 1810 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15.

Write mask registers 1815—in the embodiment illustrated, there are 8 write mask registers (k0 through k7), each 64 bits in size. In an alternate embodiment, the write mask registers 1815 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 1825—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1845, on which is aliased the MMX packed integer flat register file 1850—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

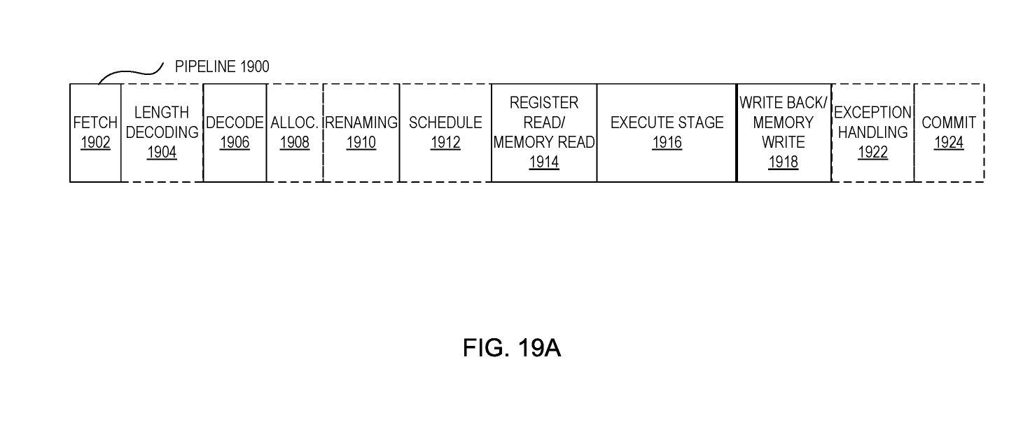

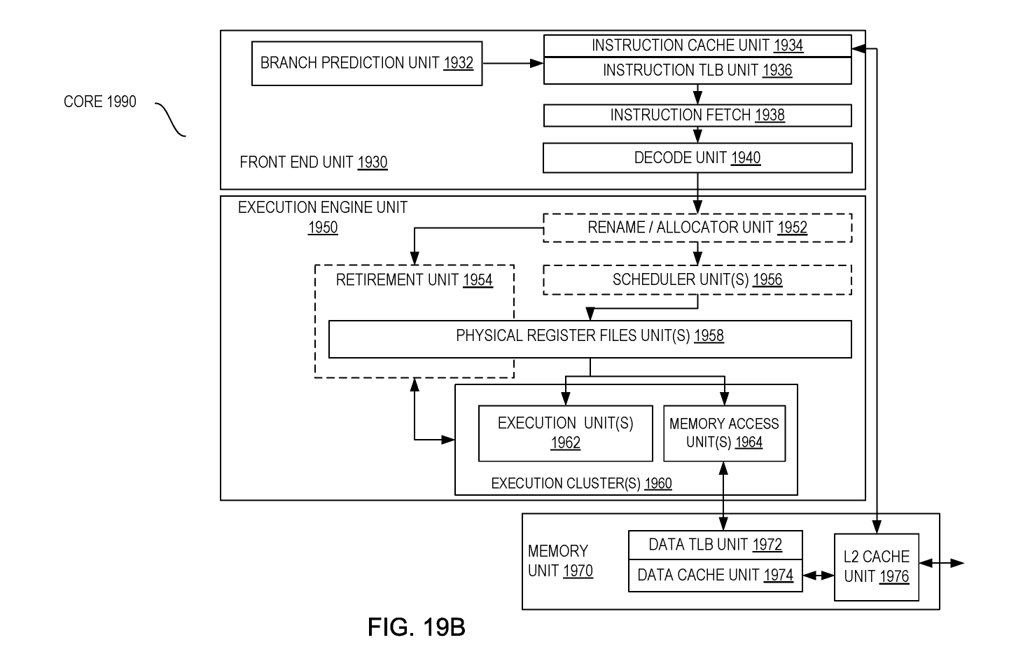

FIG. 19A is a block diagram illustrating both an exemplary in-order pipeline and an exemplary register renaming, out-of-order issue/execution pipeline according to embodiments of the invention. FIG. 19B is a block diagram illustrating both an exemplary embodiment of an in-order architecture core and an exemplary register renaming, out-of-order issue/execution architecture core to be included in a processor according to embodiments of the invention. The solid lined boxes in FIGS. 19A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 19A, a processor pipeline 1900 includes a fetch stage 1902, a length decode stage 1904, a decode stage 1906, an allocation stage 1908, a renaming stage 1910, a scheduling (also known as a dispatch or issue) stage 1912, a register read/memory read stage 1914, an execute stage 1916, a write back/memory write stage 1918, an exception handling stage 1922, and a commit stage 1924.

FIG. 19B shows processor core 1990 including a front end unit 1930 coupled to an execution engine unit 1950, and both are coupled to a memory unit 1970. The core 1990 may be a reduced instruction set computing (RISC) core, a complex instruction set computing (CISC) core, a very long instruction word (VLIW) core, or a hybrid or alternative core type. As yet another option, the core 1990 may be a special-purpose core, such as, for example, a network or communication core, compression engine, coprocessor core, general purpose computing graphics processing unit (GPGPU) core, graphics core, or the like.

The front end unit 1930 includes a branch prediction unit 1932 coupled to an instruction cache unit 1934, which is coupled to an instruction translation lookaside buffer (TLB) 1936, which is coupled to an instruction fetch unit 1938, which is coupled to a decode unit 1940. The decode unit 1940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1990 includes a microcode ROM or other medium that stores microcode for certain macroinstructions (e.g., in decode unit 1940 or otherwise within the front end unit 1930). The decode unit 1940 is coupled to a rename/allocator unit 1952 in the execution engine unit 1950.

The execution engine unit 1950 includes the rename/allocator unit 1952 coupled to a retirement unit 1954 and a set of one or more scheduler unit(s) 1956. The scheduler unit(s) 1956 represents any number of different schedulers, including reservations stations, central instruction window, etc. The scheduler unit(s) 1956 is coupled to the physical register file(s) unit(s) 1958. Each of the physical register file(s) units 1958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1958 comprises a vector registers unit, a write mask registers unit, and a scalar registers unit. These register units may provide architectural vector registers, vector mask registers, and general purpose registers. The physical register file(s) unit(s) 1958 is overlapped by the retirement unit 1954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1954 and the physical register file(s) unit(s) 1958 are coupled to the execution cluster(s) 1960. The execution cluster(s) 1960 includes a set of one or more execution units 1962 and a set of one or more memory access units 1964. The execution units 1962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1956, physical register file(s) unit(s) 1958, and execution cluster(s) 1960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1964). It should also be understood that where separate pipelines are used, one or more of these pipelines may be out-of-order issue/execution and the rest in-order.

The set of memory access units 1964 is coupled to the memory unit 1970, which includes a data TLB unit 1972 coupled to a data cache unit 1974 coupled to a level 2 (L2) cache unit 1976. In one exemplary embodiment, the memory access units 1964 may include a load unit, a store address unit, and a store data unit, each of which is coupled to the data TLB unit 1972 in the memory unit 1970. The instruction cache unit 1934 is further coupled to a level 2 (L2) cache unit 1976 in the memory unit 1970. The L2 cache unit 1976 is coupled to one or more other levels of cache and eventually to a main memory.

By way of example, the exemplary register renaming, out-of-order issue/execution core architecture may implement the pipeline 1900 as follows: 1) the instruction fetch 1938 performs the fetch and length decoding stages 1902 and 1904; 2) the decode unit 1940 performs the decode stage 1906; 3) the rename/allocator unit 1952 performs the allocation stage 1908 and renaming stage 1910; 4) the scheduler unit(s) 1956 performs the schedule stage 1912; 5) the physical register file(s) unit(s) 1958 and the memory unit 1970 perform the register read/memory read stage 1914; the execution cluster 1960 perform the execute stage 1916; 6) the memory unit 1970 and the physical register file(s) unit(s) 1958 perform the write back/memory write stage 1918; 7) various units may be involved in the exception handling stage 1922; and 8) the retirement unit 1954 and the physical register file(s) unit(s) 1958 perform the commit stage 1924.

The core 1990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1934/1974 and a shared L2 cache unit 1976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

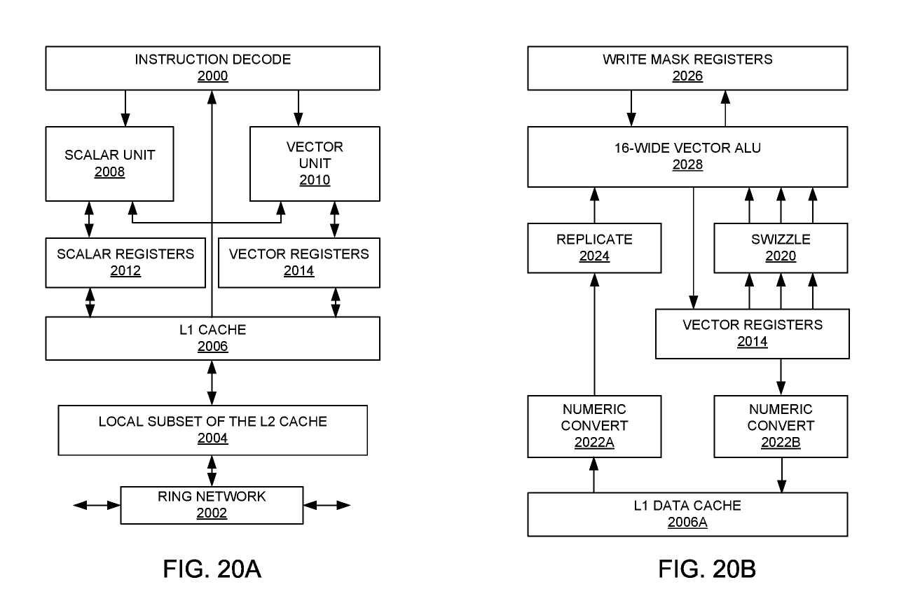

FIGS. 20A, 20B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 20A is a block diagram of a single processor core, along with its connection to the on-die interconnect network 2002 and with its local subset of the Level 2 (L2) cache 2004, according to embodiments of the invention. In one embodiment, an instruction decoder 2000 supports the x86 instruction set with a packed data instruction set extension. An L1 cache 2006 allows low-latency accesses to cache memory into the scalar and vector units. While in one embodiment (to simplify the design), a scalar unit 2008 and a vector unit 2010 use separate register sets (respectively, scalar registers 2012 and vector registers 2014) and data transferred between them is written to memory and then read back in from a level 1 (L1) cache 2006, alternative embodiments of the invention may use a different approach (e.g., use a single register set or include a communication path that allow data to be transferred between the two register files without being written and read back).

The local subset of the L2 cache 2004 is part of a global L2 cache that is divided into separate local subsets, one per processor core. Each processor core has a direct access path to its own local subset of the L2 cache 2004. Data read by a processor core is stored in its L2 cache subset 2004 and can be accessed quickly, in parallel with other processor cores accessing their own local L2 cache subsets. Data written by a processor core is stored in its own L2 cache subset 2004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 20B is an expanded view of part of the processor core in FIG. 20A according to embodiments of the invention. FIG. 20B includes an L1 data cache 2006A part of the L1 cache 2004, as well as more detail regarding the vector unit 2010 and the vector registers 2014. Specifically, the vector unit 2010 is a 16-wide vector processing unit (VPU) (see the 16-wide ALU 2028), which executes one or more of integer, single-precision float, and double-precision float instructions. The VPU supports swizzling the register inputs with swizzle unit 2020, numeric conversion with numeric convert units 2022A-B, and replication with replication unit 2024 on the memory input. Write mask registers 2026 allow predicating resulting vector writes.

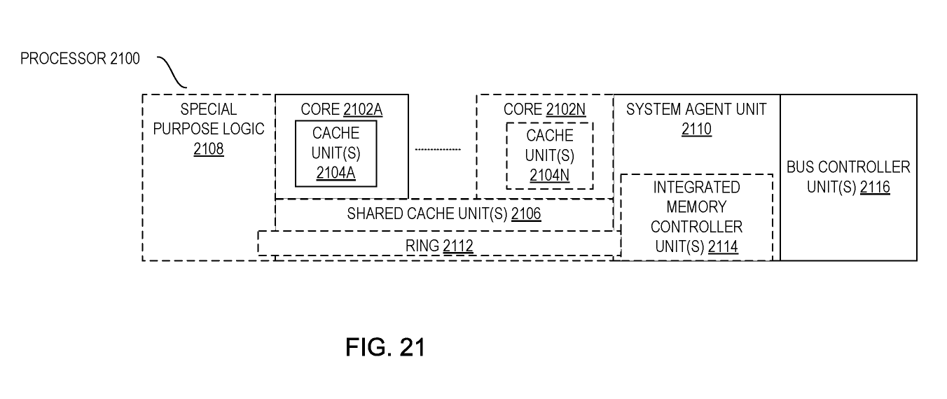

FIG. 21 is a block diagram of a processor 2100 that may have more than one core, may have an integrated memory controller, and may have integrated graphics according to embodiments of the invention. The solid lined boxes in FIG. 21 illustrate a processor 2100 with a single core 2102A, a system agent 2110, a set of one or more bus controller units 2116, while the optional addition of the dashed lined boxes illustrates an alternative processor 2100 with multiple cores 2102A-N, a set of one or more integrated memory controller unit(s) 2114 in the system agent unit 2110, and special purpose logic 2108.

Thus, different implementations of the processor 2100 may include: 1) a CPU with the special purpose logic 2108 being integrated graphics and/or scientific (throughput) logic (which may include one or more cores), and the cores 2102A-N being one or more general purpose cores (e.g., general purpose in-order cores, general purpose out-of-order cores, a combination of the two); 2) a coprocessor with the cores 2102A-N being a large number of special purpose cores intended primarily for graphics and/or scientific (throughput); and 3) a coprocessor with the cores 2102A-N being a large number of general purpose in-order cores. Thus, the processor 2100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 2100 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 2106, and external memory (not shown) coupled to the set of integrated memory controller units 2114. The set of shared cache units 2106 may include one or more mid-level caches, such as level 2 (L2), level 3 (L3), level 4 (L4), or other levels of cache, a last level cache (LLC), and/or combinations thereof. While in one embodiment a ring based interconnect unit 2112 interconnects the integrated graphics logic 2108, the set of shared cache units 2106, and the system agent unit 2110/integrated memory controller unit(s) 2114, alternative embodiments may use any number of well-known techniques for interconnecting such units. In one embodiment, coherency is maintained between one or more cache units 2106 and cores 2102-A-N.

In some embodiments, one or more of the cores 2102A-N are capable of multi-threading. The system agent 2110 includes those components coordinating and operating cores 2102A-N. The system agent unit 2110 may include for example a power control unit (PCU) and a display unit. The PCU may be or include logic and components needed for regulating the power state of the cores 2102A-N and the integrated graphics logic 2108. The display unit is for driving one or more externally connected displays.

The cores 2102A-N may be homogenous or heterogeneous in terms of architecture instruction set; that is, two or more of the cores 2102A-N may be capable of execution the same instruction set, while others may be capable of executing only a subset of that instruction set or a different instruction set.

Program code may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

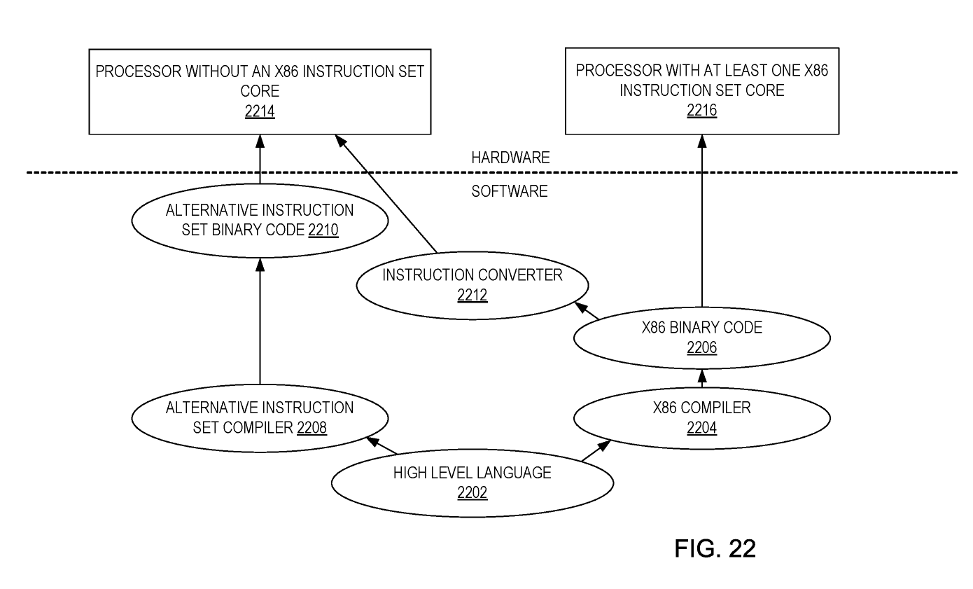

FIG. 22 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 22 shows a program in a high level language 2202 may be compiled using an x86 compiler 2204 to generate x86 binary code 2206 that may be natively executed by a processor with at least one x86 instruction set core 2216. The processor with at least one x86 instruction set core 2216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2204 represents a compiler that is operable to generate x86 binary code 2206 (e.g., object code) that can, with or without additional linkage processing, be executed on the processor with at least one x86 instruction set core 2216. Similarly, FIG. 22 shows the program in the high level language 2202 may be compiled using an alternative instruction set compiler 2208 to generate alternative instruction set binary code 2210 that may be natively executed by a processor without at least one x86 instruction set core 2214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2212 is used to convert the x86 binary code 2206 into code that may be natively executed by the processor without an x86 instruction set core 2214. This converted code is not likely to be the same as the alternative instruction set binary code 2210 because an instruction converter capable of this is difficult to make; however, the converted code will accomplish the general operation and be made up of instructions from the alternative instruction set. Thus, the instruction converter 2212 represents software, firmware, hardware, or a combination thereof that, through emulation, simulation or any other process, allows a processor or other electronic device that does not have an x86 instruction set processor or core to execute the x86 binary code 2206.

The following examples pertain to further embodiments.

In one example, a processor includes: a cache memory to store a plurality of cache lines; and a cache controller to control the cache memory. The cache controller may include a control circuit to allocate a virtual write buffer within the cache memory in response to a bandwidth on an interconnect to couple the processor with a memory that exceeds a first bandwidth threshold. The cache controller may further include a replacement circuit to control eviction of cache lines from the cache memory.

In an example, the control circuit is to cause the replacement circuit to update a replacement policy in response to the allocation of the virtual write buffer.

In an example, the update to the replacement policy comprises a switch to a least recently used clean policy in which cache lines including unmodified data are to be preferentially evicted from the cache memory.

In an example, the control circuit is to initiate a drain of the virtual write buffer in response to the bandwidth on the interconnect being less than a second bandwidth threshold.

In an example, the replacement circuit, during the drain, is to write a cache line including modified data to the memory and maintain the cache line in the cache memory, where the cache line is within a threshold distance of a least recently used position.

In an example, the control circuit is further to update a state of the cache line including the modified data to a clean state.

In an example, the cache controller comprises a first set of hit counters associated with corresponding positions within a least recently used stack, and to be updated in response to read hits within the cache memory.

In an example, the cache controller comprises a second set of hit counters associated with corresponding positions within the least recently used stack, and to be updated in response to write hits within the cache memory.

In an example, the control circuit is to dynamically update a size of the virtual write buffer based on hit histogram information obtained from at least one of the first set of hit counters and the second set of hit counters.

In an example, the virtual write buffer comprises one or more ways of a plurality of sets of the cache memory.

In an example, the one or more ways comprises N least recently used ways of the plurality of sets of the cache memory, where N is dynamically controllable.

In an example, the cache controller is to initiate a drain of the virtual write buffer in response to a number of the plurality of sets having the one or more ways that store dirty data that exceeds a threshold.

In another example, a method comprises: monitoring a bandwidth of an interconnect that couples a processor to a memory; in response to the bandwidth exceeding a first bandwidth threshold, allocating a virtual write buffer in a cache memory of the processor; and dynamically controlling a size of the virtual write buffer based at least in part on hit histogram information.

In an example, the method further comprises: monitoring a consumption of the virtual write buffer; and initiating a draining of the virtual write buffer in response to the consumption exceeding a threshold.

In an example, the draining comprises: writing dirty data from a plurality of cache lines of the virtual write buffer to the memory; and updating a state of the plurality of cache lines of the virtual write buffer to a clean state.

In an example, the method further comprises initiating a draining of the virtual write buffer in response to the bandwidth being less than a second bandwidth threshold.

In an example, allocating the virtual write buffer comprises updating a replacement policy of the cache memory to preferentially evict clean data instead of dirty data.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In another example, a system comprises a processor that includes: a plurality of cores each including a first level cache memory and a cache memory hierarchy coupled to the plurality of cores. The cache memory hierarchy may include: the first level cache memory included in the plurality of cores; and a shared cache memory coupled to the first level cache memory. The shared cache memory may include: a cache controller to control the shared cache memory, the cache controller including a control circuit, in response to a bandwidth on a memory interconnect that couples the processor with a memory that exceeds a first bandwidth threshold, to allocate a virtual write buffer within the shared cache memory and update a replacement policy to preferentially evict clean data from the shared cache memory. The processor may further include a memory controller to interact with the memory and maintain bandwidth information for the memory interconnect. The system may further include the memory interconnect to couple the processor to the memory, and the memory coupled to the processor via the memory interconnect.

In an example, the control circuit is to initiate a drain of the virtual write buffer in response to the bandwidth on the memory interconnect being less than a second bandwidth threshold, and where the cache controller, during the drain, is to write a cache line including modified data to the memory and maintain the cache line in the shared cache memory, where the cache line is within a threshold distance of a least recently used position.

In an example, the cache controller comprises a set of hit counters associated with corresponding positions within a least recently used stack of the shared cache memory, and to be updated in response to hits within the shared cache memory, and where the control circuit is to dynamically update a size of the virtual write buffer based on hit histogram information obtained from the set of hit counters.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1: A processor comprising:
a cache memory to store a plurality of cache lines; and
a cache controller to control the cache memory, the cache controller including a control circuit to allocate a virtual write buffer within the cache memory in response to a bandwidth on an interconnect that couples the processor with a memory that exceeds a first bandwidth threshold, the cache controller further including a replacement circuit to control eviction of cache lines from the cache memory.

2: The processor of claim 1, wherein the control circuit is to cause the replacement circuit to update a replacement policy in response to the allocation of the virtual write buffer.

3: The processor of claim 2, wherein the update to the replacement policy comprises a switch to a least recently used clean policy in which cache lines including unmodified data are to be preferentially evicted from the cache memory.

4: The processor of claim 1, wherein the control circuit is to initiate a drain of the virtual write buffer in response to the bandwidth on the interconnect being less than a second bandwidth threshold.

5: The processor of claim 4, wherein the replacement circuit, during the drain, is to write a cache line including modified data to the memory and maintain the cache line in the cache memory, wherein the cache line is within a threshold distance of a least recently used position.

6: The processor of claim 5, wherein the control circuit is further to update a state of the cache line including the modified data to a clean state.

7: The processor of claim 1, wherein the cache controller comprises a first set of hit counters associated with corresponding positions within a least recently used stack, and to be updated in response to read hits within the cache memory.

8: The processor of claim 7, wherein the cache controller comprises a second set of hit counters associated with corresponding positions within the least recently used stack, and to be updated in response to write hits within the cache memory.

9: The processor of claim 8, wherein the control circuit is to dynamically update a size of the virtual write buffer based on hit histogram information obtained from at least one of the first set of hit counters and the second set of hit counters.

10: The processor of claim 1, wherein the virtual write buffer comprises one or more ways of a plurality of sets of the cache memory.

11: The processor of claim 10, wherein the one or more ways comprises N least recently used ways of the plurality of sets of the cache memory, wherein N is dynamically controllable.

12: The processor of claim 10, wherein the cache controller is to initiate a drain of the virtual write buffer in response to a number of the plurality of sets having the one or more ways that store dirty data that exceeds a threshold.

13: A non-transitory machine-readable medium having stored thereon instructions, which if performed by a machine cause the machine to perform a method comprising:
monitoring a bandwidth of an interconnect that couples a processor to a memory;
in response to the bandwidth exceeding a first bandwidth threshold, allocating a virtual write buffer in a cache memory of the processor; and
dynamically controlling a size of the virtual write buffer based at least in part on hit histogram information.

14: The non-transitory machine-readable medium of claim 13, wherein the method further comprises:
monitoring a consumption of the virtual write buffer; and
initiating a draining of the virtual write buffer in response to the consumption exceeding a threshold.

15: The non-transitory machine-readable medium of claim 14, wherein the draining comprises:
writing dirty data from a plurality of cache lines of the virtual write buffer to the memory; and
updating a state of the plurality of cache lines of the virtual write buffer to a clean state.

16: The non-transitory machine-readable medium of claim 13, wherein the method further comprises initiating a draining of the virtual write buffer in response to the bandwidth being less than a second bandwidth threshold.

17: The non-transitory machine-readable medium of claim 13, wherein allocating the virtual write buffer comprises updating a replacement policy of the cache memory to preferentially evict clean data instead of dirty data.

18: A system comprising:
a processor comprising:
a plurality of cores each including a first level cache memory; and
a cache memory hierarchy coupled to the plurality of cores, the cache memory hierarchy including:
the first level cache memory included in the plurality of cores;
a shared cache memory coupled to the first level cache memory, the shared cache memory including:
a cache controller to control the shared cache memory, the cache controller including a control circuit, in response to a bandwidth on a memory interconnect that couples the processor with a memory that exceeds a first bandwidth threshold, to allocate a virtual write buffer within the shared cache memory and update a replacement policy to preferentially evict clean data from the shared cache memory; and
a memory controller to interact with the memory and maintain bandwidth information for the memory interconnect;
the memory interconnect to couple the processor to the memory; and
the memory coupled to the processor via the memory interconnect.

19: The system of claim 18, wherein the control circuit is to initiate a drain of the virtual write buffer in response to the bandwidth on the memory interconnect being less than a second bandwidth threshold, and wherein the cache controller, during the drain, is to write a cache line including modified data to the memory and maintain the cache line in the shared cache memory, wherein the cache line is within a threshold distance of a least recently used position.

20: The system of claim 18, wherein the cache controller comprises a set of hit counters associated with corresponding positions within a least recently used stack of the shared cache memory, and to be updated in response to hits within the shared cache memory, and wherein the control circuit is to dynamically update a size of the virtual write buffer based on hit histogram information obtained from the set of hit counters.
